(19) United States
(12) Patent Application Publication
(10) Pub. No.: US 2022/0303502 A1
(43) Pub. Date: Sep. 22, 2022

(54) LEVERAGING A NETWORK OF MICROPHONES FOR INFERRING ROOM LOCATION AND SPEAKER IDENTITY FOR MORE ACCURATE TRANSCRIPTIONS AND SEMANTIC CONTEXT ACROSS MEETINGS

(71) Applicant: Vowel, Inc., New York, NY (US)

(72) Inventors: Paul Tepper Fisher, New York, NY (US); Andrew Berman, New York, NY (US); Matthew Slotkin, New York, NY (US); Jiancheng Zhu, Shanghai (CN); Benjamin Kempe, Berlin (DE)

(73) Assignee: Vowel, Inc., New York, NY (US)

(21) Appl. No.: 17/836,768

(22) Filed: Jun. 9, 2022

Related U.S. Application Data
(63) Continuation of application No. PCT/US2020/063950, filed on Dec. 9, 2020.
(60) Provisional application No. 62/945,774, filed on Dec. 9, 2019.

(51) Int. Cl. H04N 7/15; H04N 7/14; H04L 67/104; H04R 3/00; G10L 15/26

(52) U.S. Cl. CPC H04N 7/152; H04N 7/147; H04L 67/104; H04R 3/005; G10L 15/26

(57) ABSTRACT

In conventional audio and video conferencing, connecting the devices of participants in the same room to the conference can degrade the audio quality for every conference participant. Different speakers emit the same audio signals at different times, even in the same room, making echo cancellation difficult or impossible. Routing signals among devices in the same consumes bandwidth and introduces variable latency. The inventive conferencing technology eliminates these problems with more intelligent routing and mixing. An inventive conference bridge organize colocated clients into groups, picks one Elected Speaker per group, and sends signals to only the Elected Speakers. The Elected Speakers mix audio from other groups, share it within their groups using low-latency local connections, and play the audio after a delay. The other speakers may play the audio too and use the distributed mixes for automatic echo cancellation, improving call quality in real-time, and send the processed audio directly back to the bridge.

### CROSS-REFERENCE TO RELATED APPLICATION(S)

This application is a bypass continuation of International Application No. PCT/US2020/063950, filed on Dec. 9, 2020, which in turn claims the priority benefit, under 35 U.S.C. § 119(e), of U.S. Application No. 62/945,774, filed on Dec. 9, 2019. Each of these applications is incorporated herein by reference in its entirety.

### BACKGROUND

In a conventional audio conferencing system, each audio conferencing device or client in the system performs on-device acoustic echo cancellation (AEC) to prevent its microphone from transmitting the inbound audio playing from its speakers. AEC works by comparing a device's microphone signal against a reference stream—an audio stream, such as the speaker output, that AEC will attempt to “cancel.” In a conventional conferencing system, the reference stream could be the audio stream from the client of any other participant client in the conference, since these participants' voices should be removed from the input signal recorded by a given audio conferencing device. AEC attempts to identify the reference stream in the microphone signal and then remove the audio represented by that reference stream from the microphone signal before transmitting the microphone signal to other audio conferencing devices.

FIG. 1 illustrates AEC in a normal conference call, using a conventional conferencing system, between person A and person Z. Person A is in room 1 and uses a first client device 120a, also called a conferencing device or client, to connect to a conference server or host platform 110, via the internet or another suitable packet-switched network. Similarly, person Z is in room 2 and uses a second client device 120z to connect to the host platform 110 via the internet. Each client 120a, 120z can be a smartphone, tablet, laptop, or other computing device with a microphone to capture audio signals, including speech and other sounds; a speaker to play audio signals, including speech captured by other clients; an optional camera to acquire video or other imagery; and an optional display to show video and imagery. Each client 120a, 120z includes a processor that can run suitable audio or video conferencing software (e.g., Zoom, Microsoft Teams, Google Hangouts, FaceTime, etc.) or a web browser (e.g., Chrome, Firefox, Microsoft Edge, etc.) that can connect to the host platform 110; a memory to store data and software, including the audio or video conferencing software; and a network interface, such as a Wi-Fi interface, for connecting to the host platform 110 via the internet.

During the conference call, person A speaks (101). In a basic call, person A's conferencing device 120a captures and sends person A's audio (103) to person Z's conferencing device 120z, which plays the audio out loud so that person Z can hear it (105). Besides playing person A's audio out loud, person Z's conferencing device 120z retains a buffer representing the last few seconds of person A's audio in its memory. When the microphone in person Z's conferencing device 120z picks up the sound of person A's audio coming out of the speaker in person Z's conferencing device 120z, person Z's conferencing device 120z cancels out person A's audio using standard AEC and the stored copy of person A's audio. In this case, person Z's conferencing device 120z is playing person A's audio and using person A's audio as a Reference Stream.

In this situation, person Z's conferencing device 120z only needs to cancel person A's audio once because person A's audio plays out of the speakers in person Z's conferencing device 120z exactly once. If person Z speaks, then person Z's conferencing device 120z captures person Z's audio, cancels person A's audio from the captured audio using AEC, and sends the captured audio, after AEC, to person A's conferencing device 120a via the host platform 110 (107). In other words, person Z's conferencing device 120z sends only person Z's audio to person A's conferencing device 120a, preventing echoes from corrupting or degrading the audio quality of the conference call. If a third person (person B) joined the conference call from a different location, person Z's conferencing device 120z would remove person A's audio and person B's audio, exactly once each, to prevent person Z's conferencing device 120z from feeding their audio back into the conference call.

On-device AEC typically relies on three assumptions: (1) there is a known latency range between playing the inbound audio stream (the Reference Stream) by the device speaker(s) and picking up playback of the inbound audio stream by the device microphone(s); (2) AEC has access to the reference stream before the reference stream is played out of the device speakers and picked up by the device microphone, so that the reference stream can be cancelled out of the microphone signal; and (3) there is a small, fixed distance between the device speakers and the device microphone, so that the reference stream is not affected much if at all by travel distance and acoustic degradation and distortion that might occur due to external acoustic sources.

Unfortunately, these assumptions do not always hold, even in a typical conferencing situation. For example, when a conferencing device streams to an external speaker (like an Apple TV), assumptions (1) and (3) may not hold, resulting in a failure to perform AEC reliably on the reference stream. When AEC fails or does not work as intended, there can be undesired echo (a person speaking remotely can hear their own voice) or feedback (a particular audio signal is transmitted continuously among devices without being cancelled, becoming increasingly distorted with each transmission). Echo and feedback can be extremely disruptive and are therefore extremely undesirable.

When multiple conferencing devices are colocated, none of the above assumptions about AEC hold, and negative effects can compound. To start, sound playing from one colocated device's speakers may arrive at another colocated device's microphone after an unknown interval, e.g., due to unknown distances between the two colocated devices and/or unknown/inconsistent differences in network latencies between the two colocated devices. Different network latencies may cause different devices to receive the reference stream at different times. For instance, differences in network latencies may cause a first colocated device's microphone to sense an audio stream played out of a second colocated device's speakers before the first colocated device receives the corresponding reference stream from the second colocated device. Even if the latency mismatch is not significant, distances between colocated devices introduce acoustic degradation and distortion, which make it more difficult for AEC to identify the reference stream in the microphone signal.

Other problems affect modern audio conferencing systems as well. For example, most modern audio conferencing systems operate on the assumption that there is only one connected audio conferencing device per location. This assumption greatly simplifies the problems that a conferencing system must address, including: (1) routing audio signals: each device routes its audio signal to each other connected device in the audio conferencing system; (2) audio playback: each device plays all audio that it receives from all other connected devices; and (3) one-time AEC: each device performs AEC on all audio signals that it receives exactly once.

Unknown distances and latencies between co-located audio conferencing devices may introduce other negative effects, including overlapping or repeating sounds, misrouted audio signals, and uncanceled reference streams. When colocated devices play unsynchronized audio signals, the sounds can overlap or repeat. When colocated devices send audio signals to each other, a colocated user may hear themselves through the colocated device(s) (similar to the echo effect described above). And when a colocated device performs AEC on a reference stream that it receives from a non-colocated device, it may not cancel that reference stream from the speaker outputs of other colocated devices.

FIGS. 2-5 illustrate the problems of time drift, speaker detection, routing, and echo cancelation with colocated clients in greater detail. FIG. 2 shows how time drift occurs and degrades audio quality in a normal conference call with person A and person B (not shown) both in room 1. Person A and person B use their own conferencing devices 120a and 120b, respectively, to have a conference call with person Z. When person A speaks (“1, 2, 3, 4, . . . ”; 201), her voice reaches the microphones of conferencing devices 120a and 120b at different times (203), e.g., because she is closer to one microphone than to the other microphone. Each conferencing device 120a, 120b digitizes, processes, and transmits the corresponding microphone signal to the host platform 110.

If the digitization, processing, and transmission latencies for both conferencing devices 120a and 120b are identical, then host platform 110 will receive the audio signal from conferencing device 120a before it receives the audio signal from conferencing device 120b (205). If the latencies are different, then the host platform 110 receives the audio signals at different times unless the latency difference exactly cancels the acoustic delay. If the net latency difference is large enough, then the audio signals can be significantly misaligned in time. The host platform 110 mixes the two audio signals to produce a mixed audio signal representing the sounds from room 1 (207). But because the audio signals are out-of-sync with each other, the mixed audio signal (“1, 2, 31, 42, 3, 4, . . . ”) includes an unwanted echo (209).

FIG. 3 illustrates problems with speaker detection in a room with colocated conferencing devices 120a and 120b. Person A speaks out loud (201), and the microphones of both conferencing devices 120a and 120b in room 1 detect the speech (203). If the microphone of person A's conferencing device 120a is closer to person A than person B's conferencing device 120b, it may detect a louder (higher volume) sound than person B's conferencing device 120b and automatically reduce its gain to compensate (305). Conversely, person B's conferencing device 120b may detect a softer (lower volume) sound and automatically increase its gain to compensate. Generally, more gain translates to a higher noise floor and a lower signal-to-noise ratio (SNR), so the audio signal generated by person B's conferencing device 120b may have the same or similar signal level and a lower SNR than the corresponding audio signal generated by person A's conferencing device 120a. If person B's conferencing device 120b increases this decreased SNR using appropriate signal processing techniques (307), then the conferencing devices 120a and 120b will transmit audio signals with similar or identical peak signal levels and/or SNRs to the host platform 110. Because these audio signals have been amplified and processed to have similar or identical peak signal levels and/or SNRs, the host platform 110 cannot reliably use them to determine which person is speaking, assuming that person A is as far from the microphone of conferencing device 120a and as person B is from the microphone of conferencing device 120b (309). This frustrates accurate speaker identification. In other words, the host platform 110 cannot identify the active speaker accurately from these processed signals.

FIG. 4 shows problems with routing audio signals among colocated conferencing devices in a conventional audio/video conferencing system. In this example, room 1 contains person A, person A's conferencing device 120a, person B, and person B's conferencing device 120b. Room 2 contains person Y, person Y's conferencing device 120y, person Z, and person Z's conferencing device 120z. The conferencing devices 120 are connected to the host platform 110 via the internet or another suitable network connection.

When person A speaks (401), person A's conferencing device 120a captures and sends a corresponding audio signal to the host platform 110, which routes that signal to the other conferencing devices 120b, 120y, and 120z (403). Person B's conferencing device 120b plays this audio signal in room 1 a short time later, creating annoying feedback as Person A's conferencing device 120a picks up on this delayed copy of Person A's voice. At the same time, the conferencing devices 120y and 120z play copies of the audio signal in room 2, creating doubled playback, which can create undesired echoes if the playback is not synchronized.

FIG. 5 shows how routing the same signal to different conferencing devices in the same room creates undesired feedback. In this case, conferencing device 120a in room 1 sends an audio signal representing speech by person A to the host platform 110 (501), which transmits the audio signal to conferencing device 120y in room 2. Conferencing device 120y plays this signal in room 2 (503), where it is picked up along with person Z's speech by the microphone of conferencing device 120z (505). If conferencing device 120z does not receive a copy of the audio signal originating from conferencing device 120a, then it will not be able to remove person A's speech from its microphone signal using conventional AEC because it has no reference stream for person A's speech. As a result, conferencing device 120z will send an audio signal with both person Z's speech and person A's speech back to conferencing device 120a (507), which plays the signal, producing an echo in room 1 (509). Likewise, if conferencing device 120z receives a copy of the audio signal originating from conferencing device 120a but does not play that signal out loud, then it will not perform conventional AEC because it is not expecting to cancel any output from its speaker (its speaker is off). This also produces an echo in room 1.

If conferencing device 120z receives and plays a copy of the audio signal originating from conferencing device 120a, it may perform conventional AEC based on its speaker output, but that AEC likely won't cancel sounds from the speaker of conferencing device 120y due to latency mismatch between conferencing devices 120y and 120z. In this scenario, person A's voice comes out of the speakers of person Y's conferencing device 120y and person Z's conferencing device 120z. Due to latency, person A's voice might play out of these speakers at different times (maybe the speaker of conferencing device 120z play a bit later than the speaker of conferencing device 120y, for example). In this case, conferencing device 120z would need to cancel person A's speech as played by the speaker of conferencing device 120y and, a short time later, by its own speakers. Conferencing device 120y would also have to cancel person A's speech from both sets of speakers in room 2. This is not possible with conventional AEC, so conventional conferencing systems avoid the challenge of canceling the same audio many times by precluding colocated connected devices.

Some audio conferencing systems may also perform Automatic Speech Recognition (ASR). ASR technology transcribes an input audio stream into text. ASR is typically composed of two parts: (1) an acoustic model that models the relationship between the audio signal and the phonetic units in the language; and (2) a language model that models the word sequences in the language. Some ASR systems may also include or use a diarization model to partition an input audio stream into segments according to the speaker identity.

The quality of the ASR transcription depends on: (1) the quality of the audio stream to be processed, which depends on, among other factors, the acoustic profile of microphone and the distance between the user and microphone; (2) the acoustic profile of the audio stream relative to the acoustic model of the ASR system; and (3) the domain of the content represented in the audio stream relative to the language model of the ASR system.

A significant challenge of ASR applied to audio conferencing is that some users may be too far away from a microphone that can capture and transmit their voices at a quality sufficient for high accuracy ASR. This is due to the nature of conferencing, in which many colocated users may share a single microphone, with sometimes significant distances between one or more users and the microphone. Additionally, the microphones on most audio conferencing devices (e.g., laptops and smartphones) have limited ranges, further exacerbating the problem. These microphones also tend to be directional, limiting the signals that they can capture.

Local meetings without a remote conferencing system are even more problematic for ASR systems. Local meetings do not use audio conferencing systems, so there is no digitization of the audio for a local meeting for ASR.

### SUMMARY

The inventive multi-microphone audio/video conferencing technology addresses these problems with prior audio/video conferencing. To use this technology, conference participants start an audio/video conference on a packet-switched network, such as the internet or voice over internet protocol (VoIP) network. For example, they may use an inventive conference bridge, also called a bridge server, to route and analyze audio and video streams as described below. This conference bridge can be accessed via a dedicated app or integrated with existing conferencing technology, such as a Zoom or GoToMeeting app. A hosting platform (e.g., a conference bridge or bridge server) identifies the clients (conferencing devices; e.g., laptops or smartphones) connected to the conference and their locations, including if multiple clients are in the same room. Each client is connected to the conference, regardless of its location.

The hosting platform determines the latency associated with transmitting data to and receiving data from each client, including both network and acoustic latencies, and synchronizes transmissions to the clients based on the latencies. The hosting platform routes audio and video packets to the clients based on the client locations and which conference participant is speaking. For each group of colocated clients (room/location), or Speaker Group, the hosting platform identifies one client as the Elected Speaker client. For instance, the hosting platform may select the client for that room or location with the shortest latency to the hosting platform as the Elected Speaker. In some cases, only the Elected Speaker client plays audio via its speakers; the other clients in that Speaker Group do not play any conference audio in order to reduce echo. In other cases, some or all of the clients in a room play synchronized conference audio. In both of these scenarios, every client in a given room may acquire audio signals and send those audio signals directly to the hosting platform.

Similarly, the hosting platform identifies the client in each room/location transmitting the highest fidelity audio signal as the Active Speaker client (this client may also be called the Active Device). For instance, the bridge server can leverage usage patterns and audio energy levels to determine the audio stream source (client device microphone) that is closest to the participant that is currently speaking within each room. This stream is called “the Active Speaker stream” and the participant who is speaking is called as “the Active Speaker.” The bridge server can prioritize the active speaker stream, only routing this stream to other rooms in order to conserve bandwidth as well as to prevent echo that might result from playback of the same audio source within a room at slightly different latencies. In other words, the Active Speaker's audio stream becomes the single audio source that is relayed to the clients in other rooms. And then the Elected Speaker in each room relays these Active Speaker streams to the other clients in its room.

Alternatively, the bridge server can mix all the streams from a single Speaker Group and relay the mixed streams to the Elected Speakers in the other Speaker Groups. When the bridge server (and/or media processor) are used to relay this beamformed mix in real-time (e.g., with tens to hundreds of milliseconds) to the Elected Speaker clients, the resulting audio streams have higher audio fidelity. This higher fidelity is a benefit of combining multiple audio streams within a single room via beamforming, thereby focusing on the speaker, while attenuating noise and room impulses. However, beamforming and the more accurate synchronization of the audio streams usually takes longer (and uses more CPU processing overhead) than simply relaying an Active Speaker stream and so introduces additional latency.

Conversely, relaying only the Active Speaker stream can be considered an optimization that reduces latency since it doesn't incur the overhead of beamforming. However, the audio fidelity of the Active Speaker stream may not be as good as the beamformed mix. That is because the Active Speaker stream is an approximate estimation of the microphone closest to the person speaking and may not benefit from the attenuation of room impulses, echo, and other noise improvements that are all enabled by the near real-time beamforming process. When a new participant within a speaker group begins to speak (at a different location within the physical room), the bridge server is able to dynamically switch the Active Speaker stream that is relayed to other speaker groups. The accurate clock synchronization of local participants within a speaker group is integral in ensuring that this transition (from one Active Speaker stream to another) doesn't incur audible glitches, gaps, or echo that could stem from noticeable offsets or jumps in the audio stream, caused by timing discrepancies.

Each client receives every Active Speaker stream and uses those streams as Reference Streams for AEC. In some cases, the clients receive the Active Speaker streams directly from the hosting platform; in other cases, the hosting platform broadcasts via unicast the Active Speaker streams to the Elected Speaker clients, which share them with colocated clients via respective peer-to-peer networks to further reduce network bandwidth consumption. Sharing only one stream from each room prevents or reduces the possibility of a latency-based echo.

Routing the signals this way lowers network bandwidth consumption and produces higher quality audio data, making for a better real-time experience and better accuracy for automatic transcription. In this context, higher quality implies that the audio data has less noise, echo, distortion, and/or room impulse sound that could confuse or hinder an ASR process—since the goal is to replicate the sound of the speaker as closely as possible, with as little noise as possible. The higher quality audio data also enables higher-fidelity diarization, which in turn leads to more accurate ASR. This is because ASR benefits significantly from context, as context helps disambiguate word choices. If different speakers' words are jumbled together (due to concurrent speaking), it can be much more difficult for an ASR process to identify the context or to pick the most likely word choices for a set of given sounds.

Diarization involves grouping the sounds made by each participant. These sounds can be kept separate for ASR. Diarization can be accomplished by matching each participant to a client based on audio signal strength (e.g., the loudest speaker recorded by a given microphone is the person closest to that microphone). Diarization can also be accomplished with a neural network trained to recognize the voices of the conference participants, where higher fidelity audio recordings increase the accuracy of the matching.

The higher quality audio data and correspondingly higher fidelity transcribed text make it possible to capture, save, and mine interesting data that appears in spoken conversations. Unfortunately, the shortcomings of current audio/video conferencing and ASR mean that much of this data is lost. Recordings are often too muffled or indistinct to be understood by a person, much less transcribed with ASR. Conversely, the inventive multi-mic technology produces intelligible recordings that can be transcribed more reliably with ASR.

Additionally, a multi-mic server can offload some processing from the conference bridge/host platform to the Elected Speaker clients by having the Elected Speaker clients dynamically mix external audio streams. The host platform uses multicast Domain Name System (mDNS) to identify other client devices within the Speaker Group on the same local network, in order to ensure the lowest latency route between an Elected Speaker and a participant within each Speaker Group. Dynamically mixing the audio streams on the Elected Speaker reduces network overhead (the system uses less bandwidth between the Internet and the local network, which can be a significant problem in scenarios in which there are a larger number of participants within a Speaker Group). This improves the quality of the resultant audio signal, reduces overhead on the Elected Speaker client, and reduces the probability of failure, since audio streams are sent directly from client devices to the host platform. This allows the multi-mic system to perform more intensive and accurate synchronization across audio streams within a Speaker Group, as well as reducing room noise and room impulses/reverberation, while emphasizing and focusing on the active speaker (which dynamically changes as the active speaker changes).

Client-side dynamic mixing reduces the probability of failure in at least three ways. First, there are far fewer streams relayed in this approach, compared with a typical SFU conferencing scenario. Fewer streams means less central processing unit (CPU) and network overhead for the bridge server and fewer network issues within a local Speaker Group. In a typical conferencing scenario, sending redundant streams to a room full of clients is more likely to overload the local network, creating packet drops and other network issues, than sending a single mixed stream.

Second, by relaying the mixed streams to the Elected Speaker and then having the Elected Speaker relay another mix of mixed streams over the local network to local participants, there is much more consistency in terms of latency: different clients won't receive streams (representing individual external participants) at different latencies/offsets. By ensuring that local participants have precisely the same audio mix, the AEC process is significantly more accurate and resilient. Additionally, by sending the bulk of the media traffic over the local network, there is far less risk in terms of overloading an internet connection by using too much bandwidth.

Third, if there is a problem with the Elected Speaker client (or if the Elected Speaker client leaves the meeting unexpectedly), a new Elected Speaker client is immediately elected from the other clients within the Speaker Group, allowing the mixing and local relay process to continue with minimal gaps.

The inventive technology can be implemented as a method of audio/video conferencing among participants using a first client in a first room, a second client in a second room, and a third client and a fourth client in a third room. In this method, the third client connects to a server via a network connection, and the third and fourth client connected to each other via a peer-to-peer network having a latency lower than a latency of the network connection. The third client receives a first audio signal and a second audio signal from the server via the network connection. The first and second audio signals represent sounds in the first and second rooms, respectively, captured by the first and second clients, respectively. (The server may mix the first audio signal from several audio streams captured by several clients, including the first client, in the first room.) The third client mixes the first and second audio signals to produce a mixed audio signal, then transmits the mixed audio signal to the fourth client via the peer-to-peer network. After waiting for a delay greater than the latency of the peer-to-peer network, the third client plays the mixed audio signal. The third client records a third audio signal representing speech by a person in the third room and the mixed audio signal as played by the third client. It cancels the mixed audio signal from the third audio signal, then transmits the third audio signal to the server. Similarly, the fourth client records a fourth audio signal representing the speech by the person in the third room and the mixed audio signal as played by the third client. It also cancels the mixed audio signal from the fourth audio signal, then transmits the fourth audio signal to the server, albeit without transmitting the fourth audio signal to the third client.

The third and fourth clients may determine their relative clock offset and send that relative offset to the server for synchronizing the third audio signal with the fourth audio signal. If there are many clients in the third room, the third client may exchange messages with each of these other clients via the peer-to-peer network. The clients measure the round-trip times (RTTs) of these messages and use them to estimate a maximum latency of the peer-to-peer network. The delay for playing the mixed audio signal is set to be greater than the maximum latency of the peer-to-peer network. This delay may include an error margin to account for hardware latency of each client in the third room.

The server can determine that the third and fourth clients are in the third room and select the third client to be the only client in the third room to receive the first and second audio signals. The server may also select the third client to be the only client in the third room to play the mixed audio signal. Alternatively, the fourth client can play the mixed audio signal with a delay (e.g., of 20 milliseconds, 15 milliseconds, or less) selected to synchronize playing of the mixed audio signal by the fourth client with playing of the mixed audio signal by the third client.

The server or another device can determine an identity and/or a location of the person in the third room based on the third audio signal, the fourth audio signal, and a latency between the third client and the fourth client. The server may synthesize or mix a beamformed audio signal based on the third audio signal, the fourth audio signal, the latency between the third client and the fourth client, and the identity and/or the location of the person in the room. And it may transmit the beamformed audio signal to the first and second clients but not to the third or fourth clients. The server or another processor can transcribe the beamformed audio signal using ASR or another suitable technique.

Another implementation entails connecting clients to a server and determining that a subset of the clients are in a first room. The server measures the latencies to the clients in the subset of the clients and designates the client having the lowest latency to the server as an elected speaker client. The server and elected speaker client synchronize their clocks, and the server receives clock offsets between the clock of the elected speaker client and clocks of the other clients in the subset of the clients. The server also receives audio streams from each of the clients in the subset of the clients. These audio streams representing sounds in the first room. The server aligns these audio streams based on the clock offsets and mixes them to produce a mixed audio stream for the subset of the clients in the first room. The server transmits the mixed audio stream to a client in a second room.

The server may align the audio streams based on the clock offsets by segmenting the corresponding audio streams into respective chunks based on the clock offsets; performing cross-correlations of the respective chunks; and adjusting time delays of the respective chunks based on the cross-correlations. It can mix the audio streams by estimating a location of a person speaking in the first room based on the audio streams and combining the audio streams to emphasize speech from that person. And it can transmit the mixed audio stream to the client in the second room occurs without transmitting the mixed audio stream to any clients in the first room. If desired, the server can perform speech recognition on the mixed audio stream and generate a transcription of the mixed audio stream based on the speech recognition.

In some cases, the subset of the clients is a first subset of the clients, the elected speaker is a first elected speaker, and the client in the second room is a second elected speaker client. In these cases, the server determines that a second subset of the clients is in the second room and measures latencies between itself and the clients in the second subset of the clients. The server designates the client of the second subset having the lowest latency to the server as the second elected speaker client. It transmits the mixed audio stream to the second elected speaker client, which transmits the mixed audio stream to other clients in the second room via a peer-to-peer network. It may also transmit another mixed audio stream from another subset of the clients to the second elected speaker client.

Yet another implementation involves connecting multiple client devices, including a client in a first room and at least two clients in a second room, to a host platform. The client in the first room records a first audio signal representing speech by a person in the first room and transmits that first audio signal to the host platform. The host platform selects, for the second room, an Elected Speaker client from among the at least two clients in the second room and transmits the first audio signal to only the Elected Speaker client among the at least two clients in the second room. The Elected Speaker client transmits the first audio signal to each other client in the second room via a local network and is the only client in the second room to play the first audio signal.

The host platform and/or the clients determine latencies associated with the clients in the second room. The clients in the second room capture respective audio signals representing speech by a person in the second room. The host platform synthesizes a beamformed audio signal based on the audio signals captured by the clients in the second room and the latencies associated with the clients in the second room and transmits the beamformed audio signal to the client in the first room. The clients in the second room may perform automatic echo cancellation, based on the first audio signal, before sending their audio signals to the server for synthesizing the beamformed audio signal. The server can estimate a location of the person in the first room based on the audio signals captured by the clients in the first room. And the server can estimate a location of the person in the second room based on the audio signals captured by the clients in the second room.

Yet another inventive method includes determining latencies associated with the at least two clients; capturing, by each of the clients, a corresponding first audio signal representing speech by a person in the room; determining an identity and/or a location of the person in the room based on the first audio signals and the latencies; synthesizing a second audio signal based on the first audio signals captured by the at least two clients, the latencies, and the identity and/or the location of the person in the room; and transcribing the second audio signal.

All combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein. Terminology explicitly employed herein that also may appear in any disclosure incorporated by reference should be accorded a meaning most consistent with the particular concepts disclosed herein.

### BRIEF DESCRIPTIONS OF THE DRAWINGS

The skilled artisan will understand that the drawings primarily are for illustrative purposes and are not intended to limit the scope of the inventive subject matter described herein. The drawings are not necessarily to scale; in some instances, various aspects of the inventive subject matter disclosed herein may be shown exaggerated or enlarged in the drawings to facilitate an understanding of different features. In the drawings, like reference characters generally refer to like features (e.g., functionally similar and/or structurally similar elements).

FIG. 1 illustrates normal audio or video conferencing in a conventional audio/video conferencing system with one client per room or locale.

FIG. 2 illustrates the problem of time drift in a conventional audio/video conferencing system with two clients in a single room or locale.

FIG. 3 illustrates the problem of speaker detection in a conventional audio/video conferencing system with two or more clients in a single room or locale.

FIG. 4 illustrates the problem of signal routing in a conventional audio/video conferencing system with multiple clients in each of two or more rooms or locales.

FIG. 5 illustrates the problem of feedback in a conventional audio/video conferencing system with multiple clients in a single room or locale.

FIG. 6A shows components of an inventive multi-microphone (multi-mic) audio/video conferencing system.

FIG. 6B shows the flow of audio and/or video signals through an inventive multi-mic audio/video conferencing system.

FIG. 7 illustrates a method of determining which clients, if any, are colocated and can form a Speaker Group.

FIG. 8A illustrates a process for determining offsets between the clock of an Elected Speaker client and the clocks of the other clients in the same Speaker Group.

FIG. 8B illustrates a process for synchronizing an Elected Speaker client to a conference bridge/host platform and aligning, beamforming, and transcribing audio streams from the Elected Speaker's Speaker Group.

FIG. 9 illustrates speaker identification, energy level measurements, and segmentation of an audio stream into interval windows by an inventive media processor.

FIG. 10 illustrates how an inventive multi-mic audio/video conferencing system routes audio signals between rooms with multiple clients and elected speaker selection.

FIG. 11 illustrates how an inventive multi-mic audio/video conferencing system relays audio signal between clients in the same room and how those clients perform automatic echo cancellation (AEC).

FIG. 12 illustrates routing and real-time mixing of audio streams among Speaker Groups.

FIG. 13 illustrates dual-strategy diarization.

FIG. 14 shows how an inventive multi-mic system integrates with other systems to generate high-quality, searchable meeting event data using ASR and diarization.

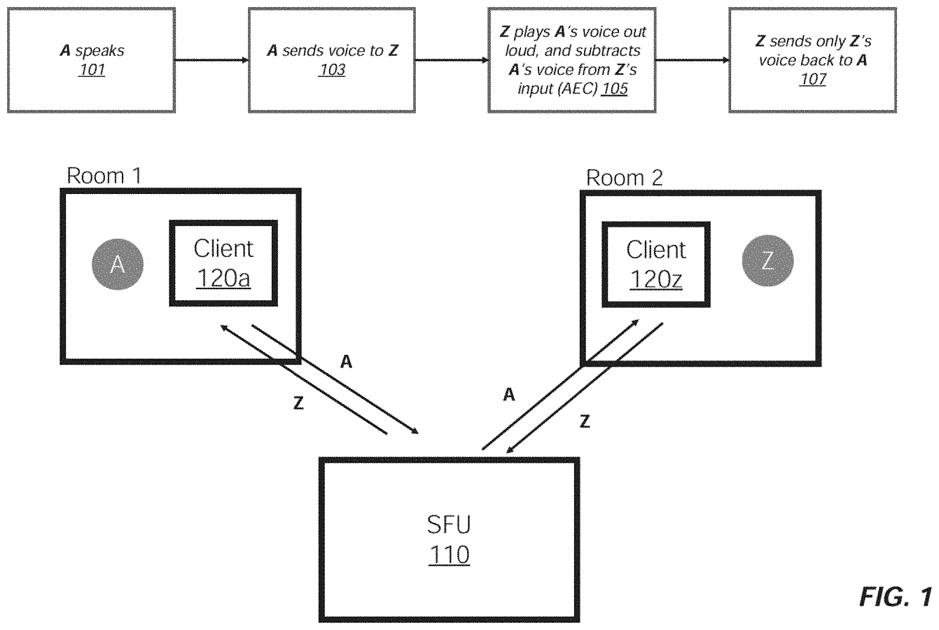

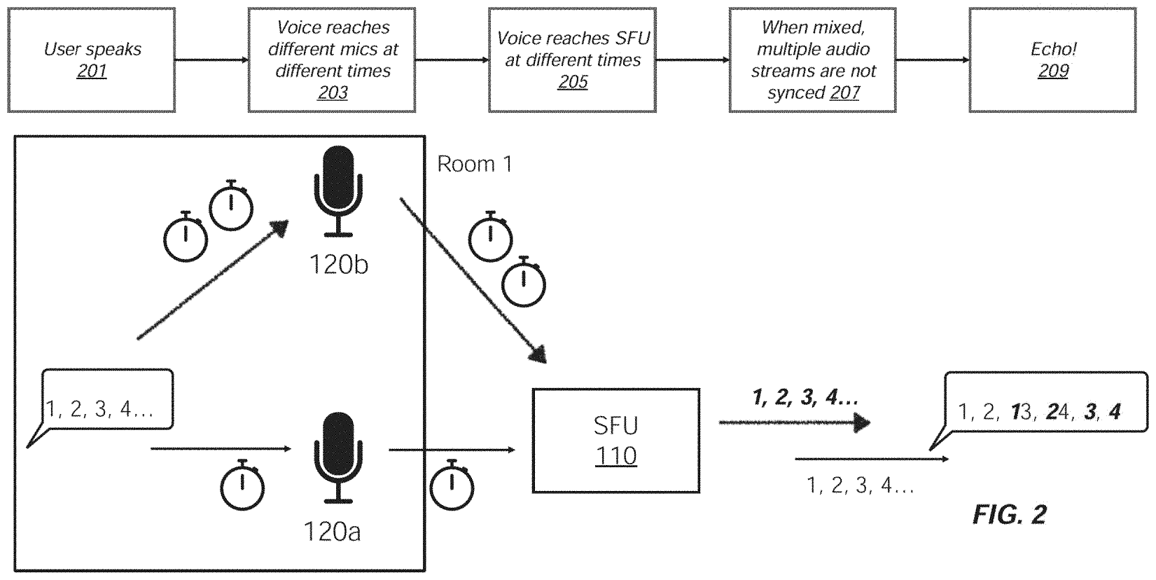

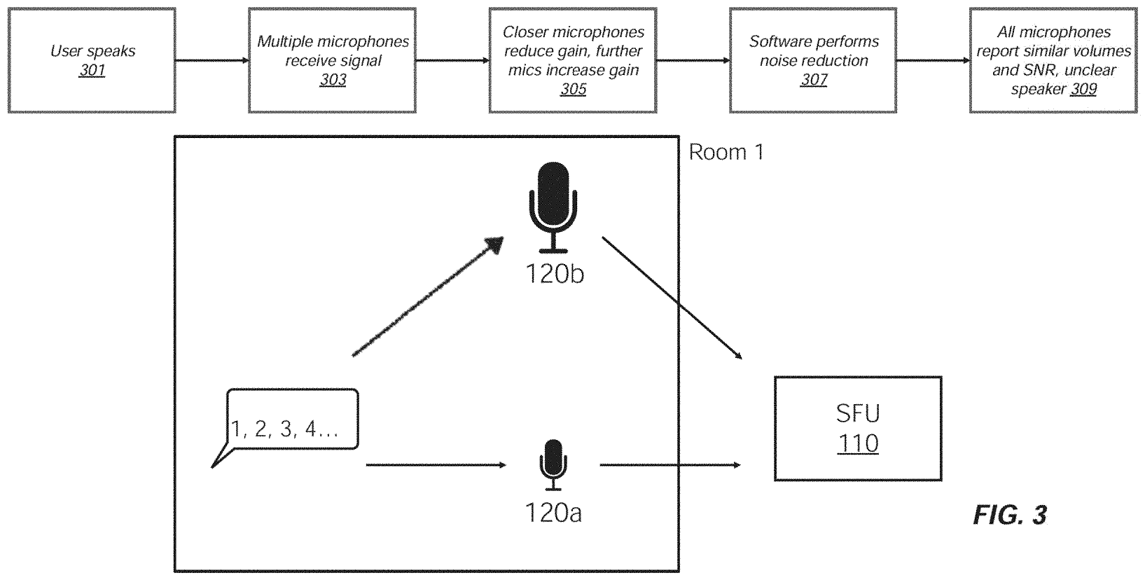

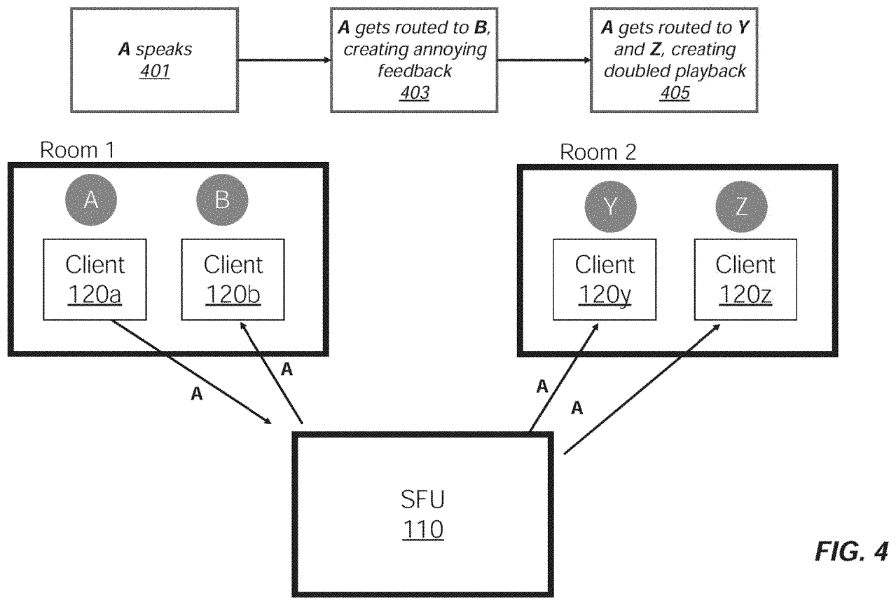

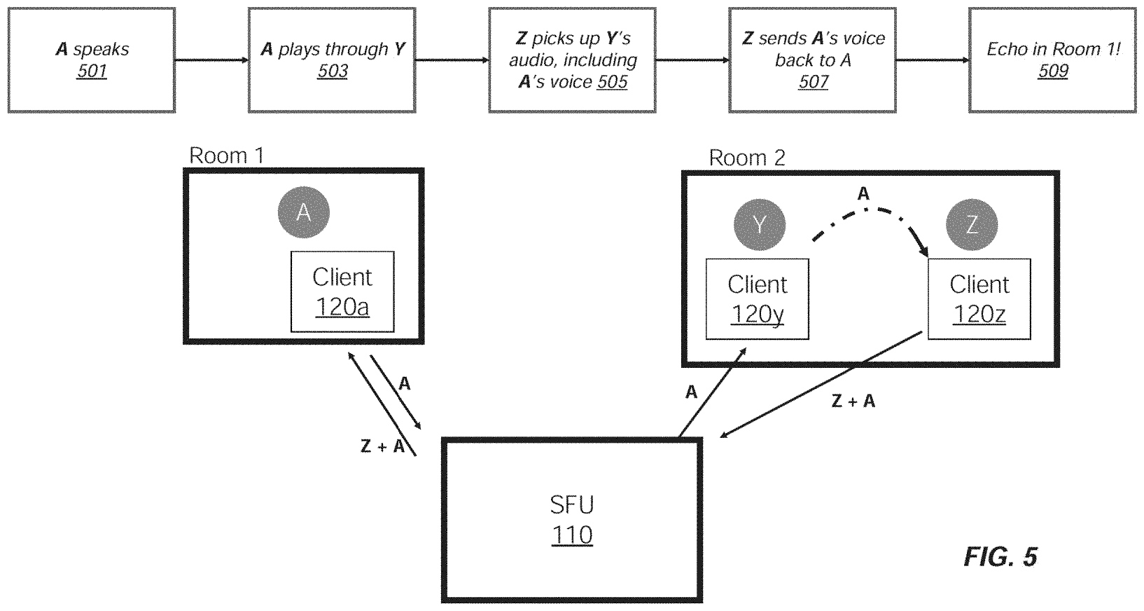

### DETAILED DESCRIPTION

The inventive multi-microphone (multi-mic) technology leverages an arbitrary number of microphones from commodity hardware (e.g., laptops or smartphones) to synthesize an array microphone, regardless of the locations and positions of the microphones relative to one another. This synthetic array microphone provides several benefits, including: (1) high-quality, real-time collaborative meeting experiences, in which the participants can use their microphones and connected devices without the acoustic feedback of traditional conferencing systems, even if the microphones and connected devices are colocated; (2) real-time audio streams and high-quality audio recordings, in which the audio streams from the microphones are captured and used to synthesize a single, high-quality audio stream, instead of capturing only one audio stream per group of colocated participants; (3) high-quality automatic transcription, in which audio streams from the microphones are leveraged to create a single, high-quality transcription, instead of transcribing only one audio stream per group of colocated participants; and (4) more accurate diarization, by determining the position of a sound source, throughout the course of a meeting (and potentially combining this data with other data points, such as the loudness of the sound source's audio signal within a given time range, audio fingerprinting, and the analysis of video frames).

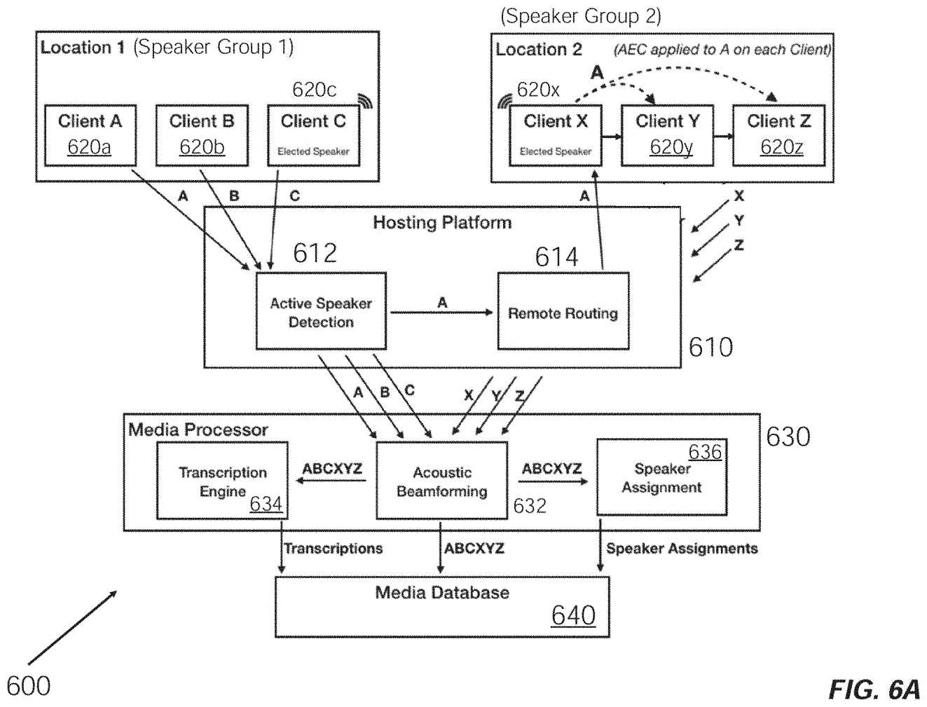

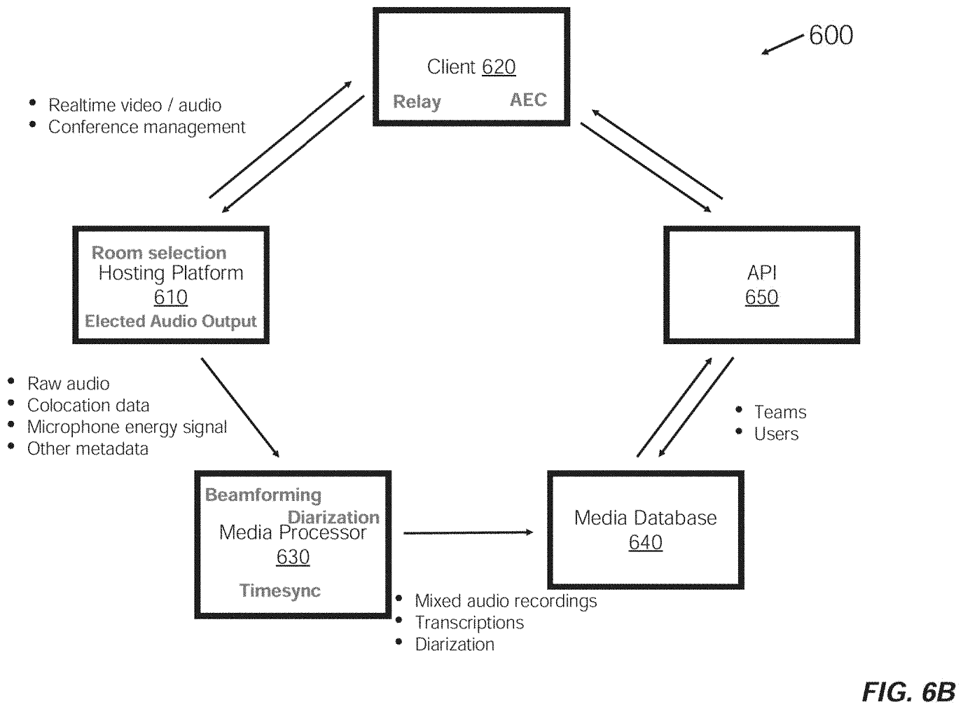

FIGS. 6A and 6B show an inventive multi-mic system 600. The system 600 includes a media processor 630 that is coupled to a media database 640 and an audio/video conference hosting platform 610, also called a bridge server or conference bridge, which in turn is connected via a packet-switched network, such as the internet or a Voice-over-Internet-Protocol (VOIP) network (not shown), to audio/video conferencing clients 620a-620c in Location 1 and clients 620x-620z in Location 2 (collectively, conferencing clients 620). Here, there is one conferencing client per conference participant: conferencing clients 620a-620c are used by persons A-C and conferencing clients 620x-620z are used by persons X-Z. Participants may also share conferencing clients 620 or use more than one conferencing client each.

The conferencing clients 620, which are also called conferencing devices or clients, can be smartphones, tablets, laptops, or other suitably configured devices. They acquire real-time audio and/or video signals, play real-time audio and/or video signals, relay audio signals and screen-sharing data to other clients in the same room, and perform AEC on audio signals that they play. They also transmit acquired video and/or audio signals to the hosting platform 610 and may receive audio and/or video signals from clients 620 in other locations via the hosting platform 610. Each conferencing client 620 has a network interface that can connect to the internet either directly or via a Wi-Fi router or other device for exchanging information with the hosting platform 610. The network interface can also connect to other clients in the same room via a peer-to-peer network. Each conferencing client 620 also has or is connected to a speaker for playing audio signals, a microphone for capturing audio signals, and a processor for routing and processing (e.g., mixing or performing AEC on) those audio signals. If a client 620 is used for video conferencing, it may also have or be connected to a display for showing video signals and a camera for capturing video signals.

The audio/video conference hosting platform 610, or simply hosting platform, conference bridge, or bridge server, receives and relays audio and video streams and metadata. It hosts real-time audio/video conferences and performs real-time determinations and calculations. It receives raw audio and/or video data, microphone energy data, colocation data, and other metadata from the clients 620 and manages the clients 620. For example, it determines if clients 620 are colocated (room selection), estimates latencies to the clients 620, adjusts bandwidth consumption, and performs many other functions. The hosting platform 610 includes an Active Speaker detection module 612 that identifies and selects the Elected Speaker and Active Speaker clients (elected audio output) for each room with colocated clients 620 based on the latency estimates and audio signals. And it includes a selective forwarding unit (SFU) 614, also called a remote routing route module 614, for routing audio and video signals to (only) the Elected Speaker for each location.

The SFU 614 receives audio and video streams over real-time transport protocol (RTP), which is used for delivering audio and video over internet protocol (IP) networks. It also receives additional metadata, such as sender-reports, timing data, bandwidth estimation metadata, etc., over real-time transport control protocol (RTCP) and then selectively relays these streams to participants in the meeting. Details on SFUs, RTP, and RTCP appear in Internet Engineering Task Force (IETF) Request for Comment (RFC) 3550 and RFC 3551, which can be found at https://tools.ietf.org/html/rfc3550 and https://tools.ietf.org/html/rfc3551, respectively, and are incorporated herein by reference in their respective entireties.

An inventive bridge server 610 differs from older conference bridges in several respects. To start, older conference bridges typically use multipoint control units (MCUs), which receive audio and video streams (as well as metadata) over RTP/RTCP. However, an MCU mixes video and audio streams in near real-time, as well as decodes, transcodes, recompresses these streams in order to reduce network overhead to the participants. However, the overhead of an MCU-based conference bridge is significantly higher (due to the decoding, transcoding, re-encoding, mixing, compositing, etc.) than the overhead of an inventive SFU-based conference bridge.

The media processor 630, also called a media processing layer, captures and processes the real-time audio and video data from the hosting platform 610, thereby creating synthesized (mixed) audio and video streams, transcriptions, speaker attribution, and other data. It can synchronize audio signals from different clients, e.g., based on clock offsets reported by the Elected or Active Speaker clients. The media processor 630 includes an acoustic beamforming module 632 that provides delays and mixes the audio signals from the clients 620 in each room to provide preferential gain for audio signals arriving at selected angles or from selected directions. It also includes a transcription engine 634, or ASR processor, and a speaker assignment module 636, both of which receive the output of the beamforming module 632. The transcription engine 634 generates a transcribed version of the beamforming module's output using ASR. And the speaker assignment module 636 uses the beamforming module's output for diarization.

The media database 640 stores data captured and created in the media processor 630, including raw and synthesized audio streams, raw and synthesized video streams, transcriptions, speaker assignments/attribution, and other data. The media server 640 serves media from the media database 630, such as synthesized audio or video streams, transcriptions, or speaker attribution, to the clients 620 and other applications. The clients 620 allow the end users (including people A-C and X-Z) to access real-time audio or video content from the hosting platform 610, relay audio and video streams to the hosting platform 610, and perform real-time processing, including dynamic acoustic echo cancellation (AEC). Each client 620 also allows a user to access non-real-time content stored by the media database 640 via the media server 630.

The system 600 may perform additional processing on extracted media frames, including pulling out additional context and metadata using optical character recognition (OCR) on media frames captured from video streams or screen-share presentations. The system 600 can include a search index/repository for clustering concurrently occurring events, such as transcription events and notes, images, slides, external API integrations to pull in references to team projects, To-Do's text-based conversations, etc. This clustering is useful for extracting and presenting key metrics over time, as well as for making extracted context and summaries from meetings searchable.

In operation, the hosting platform 610 identifies which clients 620 (and users) are colocated (i.e., located in the same room/physical location). It may route audio streams to only remote clients 620, so that colocated users do not hear their own voices through the speakers of the colocated clients 620. It selects a single device 620 per group of colocated devices 620 as the Elected Speaker client and plays other remote groups' audio from the Elected Speaker client. Each client identifies and removes remote audio streams played aloud by the colocated Elected Speaker client and picked up by its microphone.

FIG. 6A illustrates a scenario in which person A is the Active Speaker, client 620a is the Active Speaker client, and clients 620a and 620x are the Elected Speaker clients in Locations 1 and 2, respectively. The hosting platform 610 may designate the clients 620a and 620x as the Elected Speaker clients because they have the lowest network latencies of the clients in Locations 1 and 2, respectively. And the hosting platform 610 may determine the person A is the Active Speaker and designate client 620a as the Active Speaker client because the audio signal captured by the microphone of client 620a has the highest SNR and/or the highest peak signal amplitude (volume). The hosting platform 610 may change these designations in response to fluctuations in the audio signal SNRs and amplitudes and changes in the network latencies and/or connectivities.

The Active Speaker may change frequently (or infrequently) as the conference progresses. The conference bridge 610 can identify Active Speaker changes based primarily on changes in the audio streams, with a spike indicating a transition to a new Active Speaker. When one user starts speaking, their audio stream's volume will suddenly spike. Typically, the audio stream volume of whoever was speaking beforehand drops simultaneously. While it is possible for many people to be speaking at the same time, the conference bridge 610 typically picks the loudest audio steam to be the Active Speaker. However, the conference bridge 610 can support multiple active speakers, which is useful when people speak over each other, but it is fairly rare for more than three speakers to talk at the same time within a conference.

The Elected Speaker clients tend not to change as the conference progresses. The conference bridge 610 selects an Elected Speaker client based on a few heuristics: the user explicitly requests to be Elected Speaker, the user is the first participant to arrive within a Speaker Group, and/or the user's client has a reliable, low-latency network connection. The conference bridge 610 may select a new Elected Speaker client for a Speaker Group when an existing Elected Speaker client suddenly leaves the meeting, an existing Elected Speaker client experiences network issues or stability problems, or a participant requests to be the new Elected Speaker.

In this scenario, every client 620 captures audio data and sends corresponding audio signals (indicated by arrows A-C and X-Z) directly to the hosting platform 610. The hosting platform 610 identifies, in real-time, one or Active Speaker clients 620 in each location from among the clients 620 with microphones in that location. The acoustic beamforming module 632 in the media processor 630 dynamically weights and balances an arbitrary number of audio streams from the colocated clients 620 to create a clear audio mix for each room. Even though the clients 620 for each audio mix are colocated, the latencies for the streams from the colocated clients 620 may be varying, inconsistent, or both varying and inconsistent. The media processor 630 streams this mixed audio stream to the transcription engine 634 to achieve near-real-time transcription. The speaker assignment module 636 identifies which transcriptions and audio durations are attributable to which users, leveraging microphone activity signals, a real-time diarization algorithm, acoustic fingerprints, neural network-based analysis of audio and/or video frames, and previously trained x-vector models.

At the same time, the active speaker detection module 610 directs the audio signals from the Active Speaker client (here, client 620a) to the remote routing module 614, which sends those signals, and only those signals, to the Elected Speaker clients in the other locations (here, client 620x in Location 2). Alternatively, the hosting platform 610 may send the audio mixes for each location from the acoustic beamforming module 632 to the Elected Speaker clients in the other locations.

The Elected Speaker clients in the other locations route the received audio signals to the colocated clients (here, clients 620y and 620z in Location 2) via respective peer-to-peer networks (indicated by solid arrows among clients 620x, 620y, and 620z). This reduces the downstream network bandwidth consumed by the audio/video conference because the host platform 610 streams only one copy of the audio mix from each location to each other location instead of streaming one copy per client in each location. For the example in FIG. 6A, this is a two-thirds reduction in downstream bandwidth consumption because the host platform 610 routes the signal (indicated by arrow A) to client 620x and not to clients 620y and 620z.

In some cases, routing the audio signal from the Elected Speaker client 620x to the other clients 620y and 620z via the peer-to-peer network can reduce the overall latency of the playback. Peer-to-peer networks tend to have low latencies, e.g., on the order of 5 milliseconds or less. If the maximum latency in the peer-to-peer network is lower than the difference between longest and shortest latencies between the hosting platform 610 and the clients 620x-620z, then it can be faster to distribute the signals via the peer-to-peer network than via direct connections between the host platform 610 and the clients 620x-620z.

There can be a fairly broad range, in terms of network latency, between the bridge server 610 and a client 620; for example, the network latency may be 30 ms on the very low side and up to two seconds on the extremely high side. Typically, however, the network latency between the bridge server 610 and a client 620 is 80-200 ms. It is not uncommon for the network latency to spike or jump to over a few seconds. However, the bridge server 610 would likely discard packets that late for the real-time conference because clients 620 have little use for old packets once the latency exceeds the maximum buffer sizes. However, the media processor 630 may process late/stale packets for recording, transcription, and analysis packets up to a much larger latency threshold because the time constraints are not as restrictive for these more asynchronous processes.

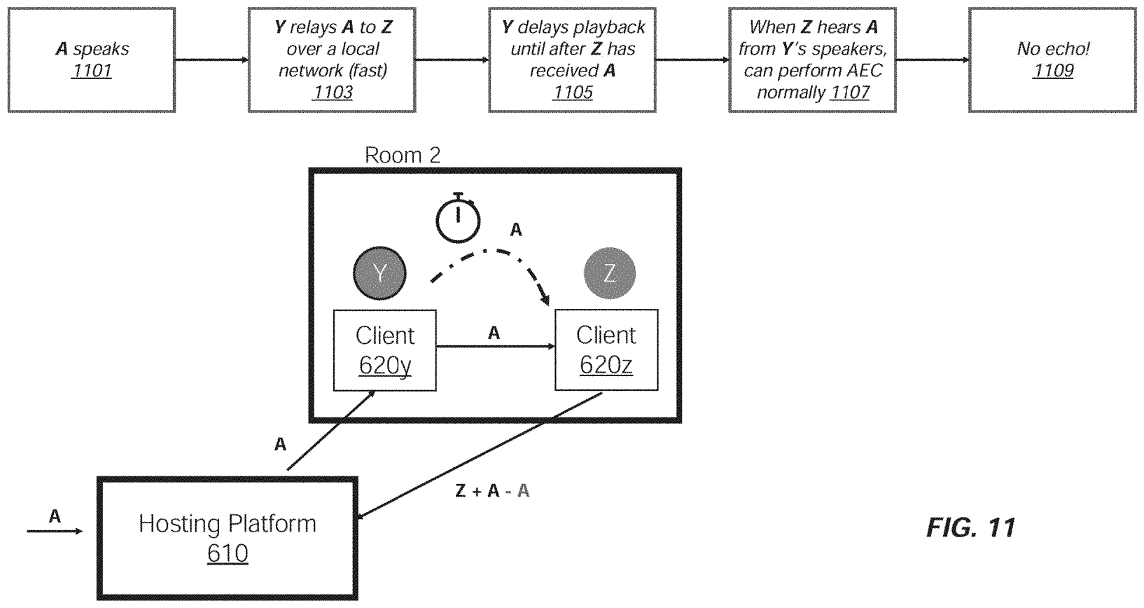

The Elected Speaker client (client 620x) plays the audio signal from person A after sending the audio signal to the other clients 620y and 620z and waiting for a period selected to be greater than the maximum latency of the peer-to-peer network connections. This delay ensures that the audio signals will reach the other clients 620y and 620z before the other clients' microphones detect the audio signal played by the Elected Speaker client's speaker. As result, the other clients 620y and 620z can use the audio signal as a Reference Stream for AEC as described below with respect to FIG. 11. Each client 620x-620z sends an audio signal captured by its microphone (indicated by arrows X-Z in FIG. 6A) back to the hosting platform 610 for mixing/beamforming and transmission to the other Elected Speaker clients.

### Room Identification and Elected Speaker Selection

In operation, the hosting platform 610 may execute a Room Identification Strategy for identifying which clients and participants are in the same location (e.g., the same room) using Bluetooth and Wi-Fi metadata, auditory beacons, network data, and/or explicit selection. Identifying colocated clients allows for the persistence (ephemeral and long-term storage) of which rooms hold which people during the conference. This data is further enhanced by leveraging auditory synchronization data, which (given the knowledge that a collection of people are in the same room) can be used with clock synchronization data (using the local room clock synchronization data mentioned above) to locate the relative positions of each participant within a room based on the different sound latencies (audio delays) at the different client microphones for different people. Estimates of the locations of the participants within a room can be used to improve the accuracy of beamforming and therefore the resultant audio mixes and down-stream transcription and diarization data.

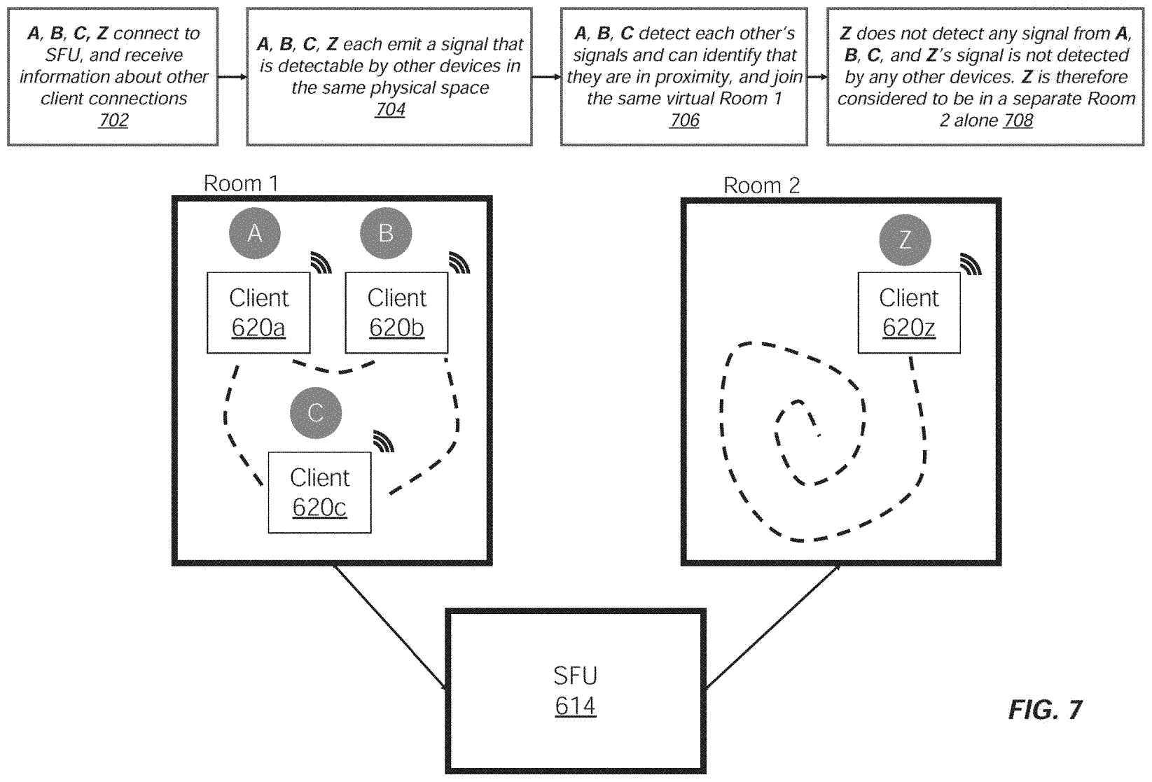

FIG. 7 illustrates how the hosting platform 610 identifies which clients 620, if any, are colocated and picks an Elected Speaker client for each set of colocated clients, or Speaker Group. To pick the Elected Speaker client for a given Speaker Group, the hosting platform 610 measures the latencies to each client in the Speaker Group. It may make a single measurement of each latency or multiple measurements of each latency. The hosting platform 610 then picks the Elected Speaker client based on these latency measurements. For instance, the hosting platform 610 may pick the client with the lowest latency, lowest average latency, or the lowest variance in latency as the Elected Speaker client.

The conferencing bridge 610 (or the SFU 614 in the conferencing bridge 610) uses the round-trip time (RTT) for each stream to determine the latency to each client 620. The SFU 614 calculates the RTT as part of the RTP/RTCP conferencing standard. Per RFC 3550, for example, the RTT can be calculated by using the metadata included in sender reports (SR messages) transmitted over RTCP. A sender report includes the last sender report timestamp as well as the delay since last sender report timestamp. The bridge server 610 uses this metadata, averaged over a period of time, to arrive at an accurate estimate of the RTT to a given client 620.

The conference bridge 610 (SFU 614) can also use clock synchronization (described below) with the Elected Speaker client in each Speaker Group and accurate clock synchronization via peer-to-peer messages among clients in each Speaker Group to improve the RTT estimation. The conference bridge 610 can use the client clock offsets to synchronize the packet timestamps received from clients within the same Speaker Group more accurately. First, the conference bridge synchronizes its clock with the Elected Speaker client's clock. Then, it synchronizes the streams from the other clients in the Speaker Group to the Elected Speaker's clock. This two-step process ensures that the packets from a given Speaker Group are accurately synchronized to each other. There may be less accurate syncing between the Elected Speaker client's clock and the conference bridge's clock (e.g., due to higher network latencies), but this does not matter as much, since the streams that originate from the same room are synchronized carefully to each other.

When an Elected Speaker client suddenly leaves a Speaker Group or is disconnected from the conference, e.g., due to computer or network issues, the conference bridge 610 automatically selects a new Elected Speaker client. Generally, the conference bridge 610 may select the immediately previous Elected Speaker client. However, if the next default Elected Speaker client doesn't have the lowest latency, or has other stability issues, then the conference bridge 610 may select a different client instead.

The hosting platform 610 also automatically identifies new clients as they join the conference and adds them to new or existing Speaker Groups. To streamline and automate identification of a new client's location, the Elected Speaker client within each room plays multi-frequency tones upon successful login of the new user. Each room, location, or Speaker Group has its own unique set of multi-frequency tones. These tones may be audible to humans, within the upper frequency end of the human hearing range, or inaudible, depending on the distance from the microphone. For instance, the tones may be outside the frequency range supported by the sampling rate of the audio stream (e.g., a tone at a frequency greater than 8 kHz for a sampling rate of 16 kHz or at a frequency greater than 22.05 kHz for a 44.1 kHz sampling rate).

When the elected speaker within a room plays its unique tone, a new client 620 in that room captures this audio data via its microphone. The new client 620 extracts and identifies the frequencies from the tone and then sends this data back to the conference bridge (hosting platform 610). When the conference bridge 610 receives this message, it can identify which room the new client 620 is in by the time and frequency data included in the message and add the new client 620 to the corresponding Speaker Group. The Elected Speaker client can be updated when a new participant with lower latency, or better performance across other metrics, than the originally selected Elected Speaker client joins the conference.

If the new client 620 does not detect any tones or return any corresponding time or frequency data to the conference bridge 610, then the conference bridge 610 may determine that the new client is not in a previously identified location or part of an existing Speaker Group. In this case, the new client 620 becomes the Elected Speaker client for the new location. If another client joins the conference from this location, then the host platform 610 can detect it using unique tones for this location as described immediately above and add it to a Speaker Group for this Elected Speaker client.

To prevent these emanated unique signature tones for each room or Speaker Group from being captured, digitized, and then routed to other rooms or Speaker Groups (which could create confusion as these tones could be played out of Elected Speaker clients 620 in the other rooms), the conference bridge 610 injects each signature tone into the corresponding Elected Speaker stream and not into any other streams. Since the conference bridge 610 knows when it sends each set of signature tones, the network latencies to the Elected Speaker clients 620, and the time offsets for receiving signals from the other clients in each Speaker Group, it can estimate when these tones will be sent back via recorded streams from other clients in the Speaker Groups. This allows the conference bridge 610 to cancel out the tones from the recorded streams, in much the same manner as AEC. The room-signature tones can be handled in a similar manner to dual-tone multi-frequency (DTMF) tones in telephony.

There are other strategies for identifying colocated clients 620. For instance, the clients 620 may broadcast and/or receive wireless signals, such as Bluetooth beacons or Wi-Fi service set identifiers (SSIDs) to identify other clients within the same room. Each client 620 sends its own identifier and indications of any received Bluetooth or Wi-Fi signals to the bridge server 610. The bridge server 610 uses these “fingerprints,” which represents the proximate Bluetooth devices or Wi-Fi SSIDs, to identify which clients are close to each other. Alternatively, the conference participants can simply identify a subset of other participants in the same room when joining the conference, thereby disambiguating the user's location. Similarly, the clients may determine that they are colocated if they all join the same local/peer-to-peer network, they

FIG. 7 shows how to identify colocated clients using high-frequency tones, Bluetooth beacon signals, Wi-Fi SSID signals, or other suitable signals. The clients 620 connect to a bridge server 610 or SFU 614 contained in a bridge server 610 and receive information from the bridge server 610 or SFU 614 about which clients 620 are joined to the conferencing session (702). Clients 620a, 620b, 620c, and 620z each emit a signal that can be detected by other clients 620 (704). Clients 620a-620c are all in Room 1 and detect each other's signals. They also join the same local network (706). Together, clients 620a-620c form a first Speaker Group. Client 620z is in Room 2 and does not detect any signals from the other clients 620a-620c, nor is its signal detected by the other clients 620a-620c, so it does not belong to the first Speaker Group (708).

### Time Synchronization and Beamforming

The conference bridge uses a multi-phased strategy for effectively detecting and synchronizing different audio stream latencies. For instance, the conferencing devices' clocks may be synchronized first to the conference bridge server's clock using a Network Time Protocol (NTP)-based clock-synchronization process. Next, the conferencing device (client) 620 within each room with the lowest stable or average latency to the server 610 is elected to be a local time-sync leader. Typically, but not always, the Elected Speaker client and local time-sync leader are the same. Then the clocks of the other conferencing devices in each room are synchronized to the clock of the local time-sync leader using a peer-to-peer (P2P) clock synchronization process. Using a P2P clock synchronization process reduces inaccuracy caused by network latency since P2P sharing has relatively low network overhead. Once the conferencing devices (clients) 620 within a room or Speaker Group are synchronized to each other and the conference bridge 610, the conference bridge 610 calculates the clock offsets between each conferencing device 620 and the local time-sync leader (Elected Speaker client) and uses these clock offsets to calculate a conferencing-device-to-server time sync.

Clock synchronization, whether between the Elected Speaker client and local clients, or between the bridge server and Elected Speaker client, involves exchanging messages with local clock times. One device sends a time synchronization message containing its local clock time to another device (e.g., a local client to the Elected Speaker client). When the other device receives the message, it responds with a new message that contains its local clock time. The devices repeat this message exchange several times at regular intervals, making it possible to identify and remove outliers and atypical delays. The devices use the remaining messages to extrapolate the RTT and their relative clock offset. Half the RTT is a rough approximation for the network latency in one direction (between a local participant and the elected speaker). Subtracting the network latency from the relative clock offsets factors out the network latency from sending messages over the network.

Put differently, a first peer (e.g., a client) sends a first message containing its own clock time to a second peer (e.g., the Elected Speaker). The second peer responds with a second message including its own clock time when (1) it received the first message and (2) when it sent the second message. The first peer receives the second message with the receive time and the send time for the response. This process (which repeats a configurable number of times, at a predefined interval of usually one second) allows the first and second peers to coordinate and to determine the relative clock offset and network latency.

The conference bridge 610 uses these offsets to adjust Real-time Transport Protocol (RTP) packet times. Once the conference bridge 610 receives the relative clock offsets, it can recalibrate the timestamps for a given stream, effectively correcting the timestamps so that streams from the same Speaker Group reflect the same time base, and are in sync with each other, regardless of the network latency from each participant (conferencing device 620) to the conference bridge 610.

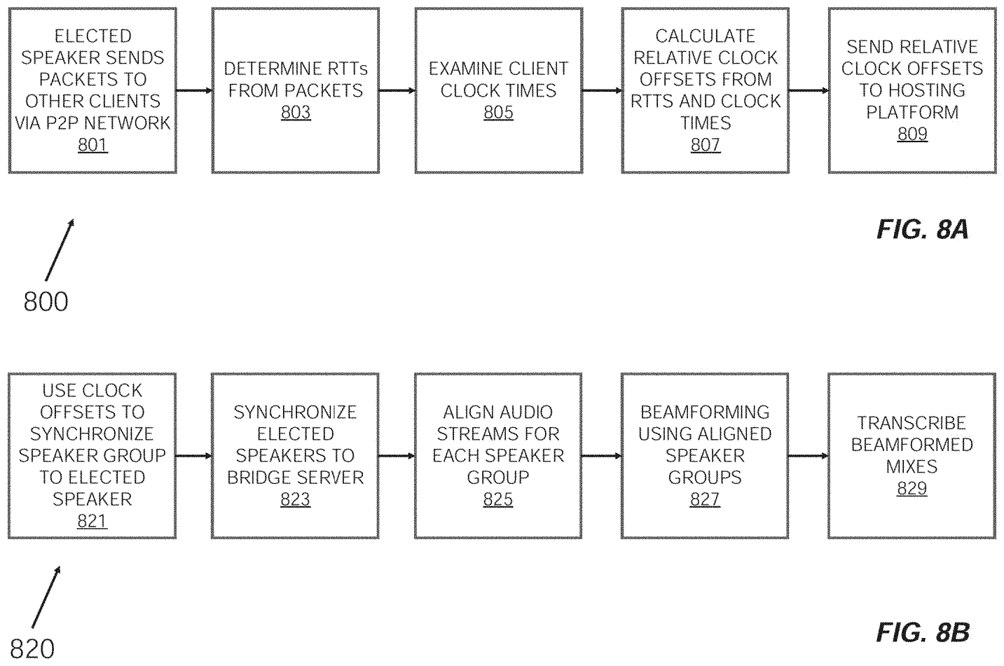

FIG. 8A illustrates a process 800 for determining the relative clock offsets between each client within a Speaker Group and the Elected Speaker client. To calculate the clock offsets, the Elected Speaker client relays packets to each other client 620 within its Speaker Group via a local peer-to-peer network (801). It uses the timestamps of these packets to determine the round-trip time (RTT) to each other client via the local peer-to-peer network (803). Additionally, the Elected Speaker client also examines the local clock time of each other client within the Speaker Group and its own local clock time (805). It then calculates a clock offset, relative to its own clock, for each other client in the Speaker Group (807). Each clock offset is based on the RTT between the Elected Speaker client and the corresponding client within the Speaker Group, the Elected Speaker client's local clock-time, the local clock-time of the corresponding client, and, optionally, an error margin. The Elected Speaker client sends these relative clock offsets to the Selective Forwarding Unit (SFU) or Bridge/Conference Server 620 (809).

FIG. 8B shows a similar process 820 that is used to determine the RTT and clock-time offset between each Elected Speaker client and the SFU. This approach allows the synchronization to happen on the server side, rather than directly within the Elected Speaker client, reducing the overhead and complexity of synchronizing streams within the Speaker Group. The process 820 in FIG. 8B is just one example of how to synchronize audio streams; other synchronization processes are also possible.

In the process 820 of FIG. 8B, a real-time media-pipeline on the server-side (hosting platform) applies the relative clock offsets between each Elected Speaker client and the other clients from that Elected Speaker client's Speaker Group to synchronize the devices within a Speaker Group to the Elected Speaker client (821). Then, each Elected Speaker client is further synchronized (using its RTT and local-clock-time offset) to the Bridge/Conference Server 610 (823). Once these synchronization steps are applied, the media-pipeline maintains a small buffer in which to further (and more accurately) align each audio stream from a given Speaker Group. The media processor 630 aligns these audio streams by iteratively processing windows of audio chunks (adjusted based on the synchronization steps outlined above) across all streams from a given Speaker Group (825). The media processor 630 calculates the cross-correlation to identify the “best fit” in which the audio samples best “match” or line-up. After calculating the initial offset using cross-correlation, the media processor 630 uses this adjusted offset to further optimize the synchronization of successive windows of audio chunks.

As the media processor 630 synchronizes each window of audio chunks (representing audio data from participants within a Speaker Group), it applies additional audio processing to these audio chunks. This additional audio processing includes beamforming by the acoustic beamforming module 632 (827). The acoustic beamforming module 632 estimates relative locations of participants within a physical room and dynamically “focuses” on the active speaker within a particular Speaker Group. It may do this by combining the signals from multiple audio streams within a room (Speaker Group) to effectively emphasize the active speaker within that room, filtering out room impulses, reverberation, echo, and other noise picked up across the microphones within a Speaker Group. This beamforming also implicitly involves combining or mixing the audio streams originating from a particular Speaker Group to a single audio stream. The beamformed mixes from the different Speaker Groups in the conference are streamed to the transcription engine 634, which performs speech recognition and transcription on the mixes (829).

Synchronizing clocks makes it possible to correlate streams by time bucket and then do a more granular and accurate synchronization by time bucket in beamforming and room/Speaker Group mixing (827 in FIG. 8B). Accurate clock synchronization also makes it possible to infer more from the beamformed streams within the context of a room. For instance, localizing the source of audio streams through the time delay of arrival across client microphones in a given Speaker Group is useful for inferring the location and identity of the active speaker (diarization).

Beamforming can be used to distinguish different speakers (i.e., the people who are speaking) within a room from each other as well as from background and room noise and to approximate the positions of speakers within a room. By combining this speaker position data with average energy levels over time ranges and historical speaker data (e.g., x-vector speaker profile data), the speaker assignment module 636 in the media processor 630 can produce more accurate diarization.

The acoustic beamforming module 632 performs beamforming by picking the reference channel that has the maximum cross correlation with other channels. Then it finds the n-best time-delay of arrival (TDOA) for every audio segment for every channel that maximizes the Generalized Cross Correlation with Phase Transform (GCC-PHAT) with the corresponding audio segment from the reference channel. After it gets the n-best TDOA for each segment for each channel, it applies a two-pass Viterbi algorithm to select the TDOAs that are most consistent within and across each channel. Then we generate the weights for each channel per segment based on its cross correlation to every other channels. Finally, the acoustic beamforming module sums the audio segment with the weights calculated from previous step and applies a triangular filter to neighboring segments within a channel.

The acoustic beamforming module 632 implemented in the media processor 630 performs blind beamforming on the temporally aligned audio streams from each Speaker Group. Beamforming can also be performed by the Elected Speakers instead of on the server side. This reduces network overhead, especially for conferences with two or more participants per Speaker Group; instead of one stream per client going to the hosting platform 620, there is one stream per Speaker Group. Client-side beamforming can also significantly improve the quality of meetings with a large numbers of collocated participants (i.e., Speaker Groups with many clients).

### Speaker Detection

By using a beamformed mix that “focuses” the audio over time based on the participant that is currently speaking (the Active Speaker), the transcription engine 634 can create a higher-quality transcription of the audio. Identifying the locations of participants relative to the client microphones in a Speaker Group is useful for focusing the audio on the active speaker (and filtering out room reverberations). It is also useful in improving the accuracy of identifying the active speaker (diarization). For example, correlating audio emanating from the same physical position within the room, over the course of a meeting can be useful for disambiguating the identification of the corresponding speaker (conference participant) by grouping these audio intervals together and combining these data points with additional context data to help deduce the actual speaker. This media processor 630 can blend this approach with additional context, leveraging video data, positional data, audio fingerprints, and audio volume, meeting participant data (i.e., invite list), external meeting data, and context extracted from transcription.

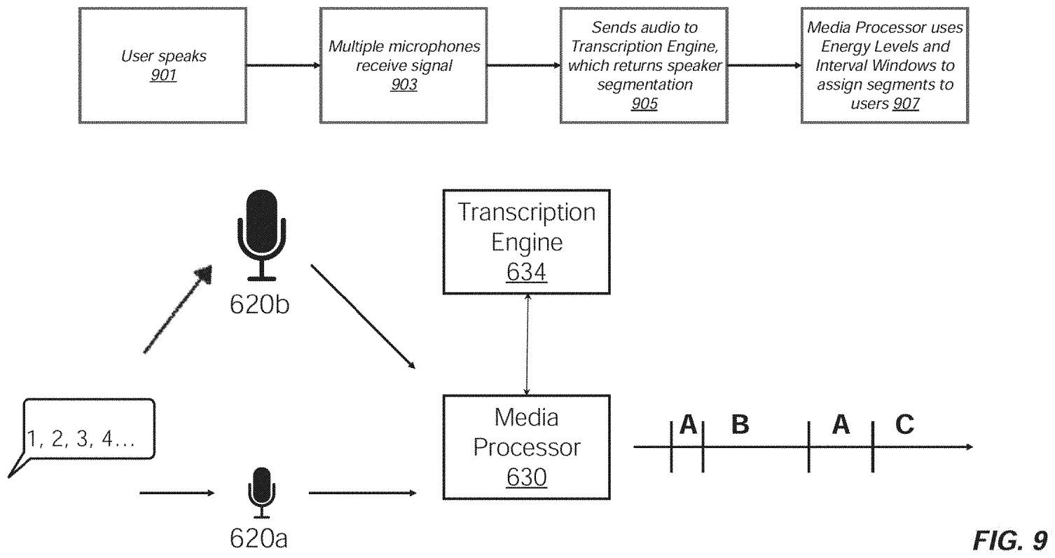

FIG. 9 illustrates how the media processor 630 and transcription engine 634 identify who is speaking and segment the transcribed speech accordingly. When a conference participant speaks (e.g., person A, B, or C) (901), the microphones of one or more of the clients (e.g., clients 620a and 620b) in the same room as that conference participant detect the participant's speech (903). The clients 620 send the audio signals captured by their microphones to the hosting platform 610, where the signals are synchronized and beamformed as described above. (The clients 620 may send metadata in every RTP packet to represent the microphone energy levels but extracting the microphone energy levels from the audio itself tends to yield higher resolution data.) The media processor 630 sends the beamformed signals to the transcription engine 634, which returns a segmented transcription of the audio signals to the media processor 630 (905). The media processor 630 assigns a participant (e.g., person A, B, or C) to each segment in the segmented transcription based on the relative locations of the participants and the client microphones.

The media processor 630 and transcription engine 634 can segment and assign participants to the audio signals using the following diarization process. The media processor 630 calculates a normalized volume for each sample in a frame of the audio signal. This normalized volume is equal to the volume divided by the moving maximum absolute volume over a certain period. Then the media processor 630 calculates the root-mean-square (rms) amplitude and kurtosis of the normalized volumes of each frame. To estimate the person speaking during a given period of time, the media processor 630 find all of the frames within that period of time from all speakers. Then it calculates a score for each person speaking. This score can be the geometric mean of the rms amplitudes of the frames for that person divided by the sum of the mean of the rms amplitudes and the average kurtosis for those frames. Additionally, this score can also factor audio fingerprints (from historical x vector data) or facial recognition probability (that the active speaker is talking). The estimated speaker is the person with the highest score.

### Room-Aware Bridge Routing

Room-aware bridge routing and AEC involves dynamically routing audio and video packets to increase bandwidth efficiency and reduce audio feedback and echo. A multi-mic system 600 can capture multiple streams of audio and video concurrently to improve audio quality, ensure proximate capture of speech by each speaker, and allow for accurate speaker attribution. However, in a real-time meeting with remote and local participants, significant audio feedback and echo are very difficult to prevent in a conventional conferencing system because the room audio may be picked up and played on multiple microphones within the same physical space. Additionally, playing audio from a remote source on colocated clients in the same room can cause echo if the colocated clients have variations in latency.

To mitigate these problems, an inventive multi-mic system may employ a dynamic routing strategy, leveraging room participant data identified and captured using the Room Identification Strategy described above. The conference bridge 610 is aware of each client 620 and its associated audio and video streams, as well as which clients 620 and participants are in which rooms/locations. Using this data, the conference bridge 610 selectively routes audio streams such that audio packets originating in each room (from a given Speaker Group) are sent only to clients outside that room (not in that Speaker Group). This prevents audio packets from being sent to (and played by) any other client in the same room (Speaker Group). A multi-mic system also uses an Elected Speaker client in each room to play audio streams received from other rooms.

A multi-mic system 600 employs a similar strategy for video packets, but is aware of the type of video content, allowing screen-share data to be routed to clients within the same originating room (Speaker Group). (This is useful for sharing presentation data without a large screen.) However, for video streams containing camera content, this approach can help significantly reduce bandwidth overhead, by not sending video packets to users in the same room or Speaker Group.

Additionally, a multi-mic system can employ an active speaker detection (ASD) process which identifies the active speaker (both within each physical room, as well as the currently active speaker across the entire meeting). The ASD process primarily uses metadata sent in the RTP packets from the client devices 620. This metadata conveys the loudness of the audio signal for the corresponding frame. The bridge server aggregates this metadata and these frames to determine the currently active speaker across all of the Speaker Groups as well as the active speaker within each Speaker Group.

The “Local Active Speaker” (the person speaking in a room at a particular moment) can be used to identify which client's microphone should be used at that particular moment in the conference. This helps ensure the shortest possible distance between the microphone to the active speaker. However, the hosting platform may route audio from only one active speaker within a room at a time to prevent other clients in the same room from capturing and replaying the same audio. If these other clients capture and replay the same audio with different latencies, they could cause perceived echo in other rooms. However, by playing audio within a physical room via only one (Elected Speaker) client and routing captured audio data from only a single (Active Speaker) client within a room at a time, and through the dynamic echo cancelation and latency estimation methods described above, the system can reduce perceived echo and feedback from occurring in most real-time conferences. Routing only the Active Speaker stream to other clients also conserves bandwidth and processing overhead and can reduce latency too. However, audio and video data are captured from every participant's device and sent to the conference bridge (hosting platform), which routes every stream to the media processor for post-processing (e.g., noise reduction, room de-reverberation, beam-forming, mixing, diarization, and transcription). If the conference bridge determines that a particular audio stream contains no significant signal, e.g., from the volume metadata sent with every RTP packet, then the conference bridge may discard packets in that audio stream to conserve processing overhead.

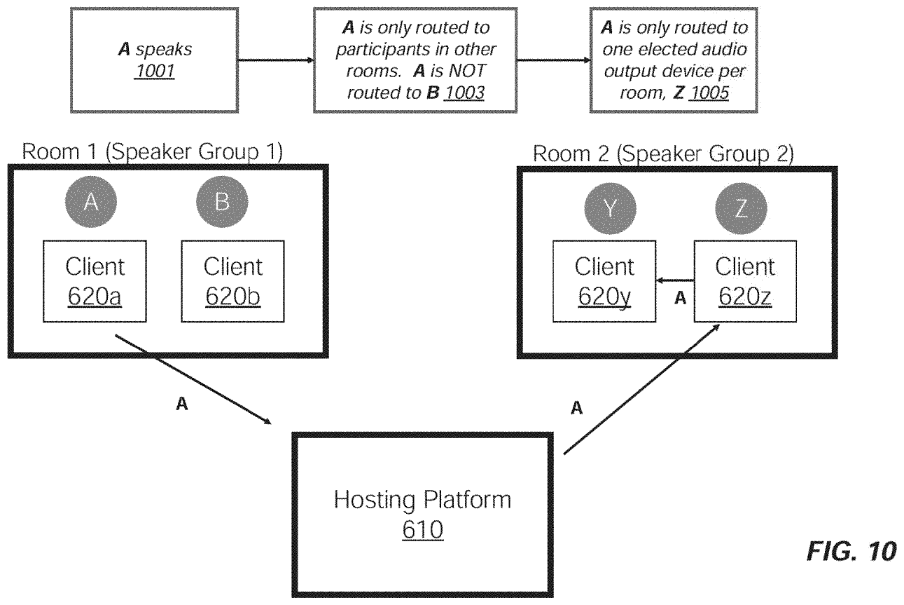

FIG. 10 illustrates selective routing among clients 620 in different rooms (Speaker Groups) in a multi-mic system. In this example, there are two Speaker Groups—Speaker Group 1 for clients 620a and 620b in room 1 and Speaker Group 2 for clients 620y and 620z in room 2. Client 620a is the Elected Speaker client for Speaker Group 1 and client 620z is the Elected Speaker for Speaker Group 2.

If person A in room 1 speaks, her speech is captured by the closest client, client 620a, which is designated the Active Speaker client or Active Device (1001). That client 620a sends a corresponding audio signal (indicated by arrow A) to the hosting platform 610. It does not send that audio signal to client 620b or any other client in room 1/Speaker Group 1 (1003). The hosting platform 610 routes the audio signal to the Elected Speakers in the other Speaker Groups, including client 620z in Speaker Group 2 (room 2). The hosting platform 610 does not send the audio signal from client 620a to client 620b or any other client in room 1/Speaker Group 1 either or to any of the clients in other Speaker Groups that are not Elected Speakers (1005). Client 620z then sends the audio signal to the other clients in Speaker Group 2 via a peer-to-peer network in room 2 (indicated by the arrow from client 620z to client 620x).

Relay and AEC within a Room

To further reduce bandwidth overhead and latency for reference audio streams (including stream data representing audio from the active speakers from other rooms that is being played via each room's Elected Speaker client), the hosting platform 610 may relay reference streams to only the Elected Speaker client 620 within each room as explained above. The Elected Speaker client then relays these packets to the other clients in the same room over peer-to-peer (p2p) or other local connections. Because this relay from the Elected Speaker client happens over p2p/local connections, the latency is significantly lower, which reduces the potential for error when it comes to echo cancellation. The bandwidth overhead for the clients within each room is also much lower.

In some cases, only one device within a Speaker Group (typically the Elected Speaker client) plays the audio at a time. This makes echo cancellation simpler because there is only one copy of the audio signal to cancel from the streams produced by the microphones of the clients in the Speaker Group. The Elected Speaker client waits for a delay greater than the maximum latency from the Elected Speaker client to the other clients in the Speaker Group, then plays the audio signal from its speaker. The delay provides enough time for the other clients to receive the (electronic domain) copy of the audio signal for use as a reference stream in AEC.

FIG. 11 illustrates AEC for a single Speaker Group with clients 620y and 620z. In this case, client 620y is the Elected Speaker client. When person A (in a different room) speaks (1101), the corresponding audio signal (represented by arrow A) arrives at the hosting platform 610, which routes it to client 620y. Client 620y relays the audio signal to client 620z via a fast (e.g., p2p) local connection (indicated by arrow between clients 620y and 620z) for use as a reference stream in AEC (1103). After waiting long enough for client 620z to receive the reference stream, client 620y plays the audio signal via its speaker (indicated by dashed arrow A)(1105). If person Z speaks while client 620y plays this audio signal, the client 620z will detect speech from person Z and an echo—the speech from person A (audio signal Z+A). Client 620z cancels the speech of person A from the audio stream (audio signal Z+A−A) using normal AEC (1107), albeit without playing any signals via its speakers. It sends the resulting echo-free signal (1109) directly to the host platform 610 (i.e., without sending it to any other client in its Speaker Group). This process can happen in real time, making it possible to decouple the active speaker and the audio output. By decoupling the active speaker from the audio output, the host platform can select and use the highest-quality microphone signal, possibly resulting in much higher quality audio in real time.

In other cases, some or all of the clients within a Speaker Group play the audio signal. In these cases, the Elected Speaker determines the physical latency (the time it takes for sound to travel between a speaker and a particular client device microphone) between its speaker (output device) and the microphones of the other clients within its Speaker Group. It then determines a subset of clients 620 that are the farthest away from most other clients 620. Then, the Elected Speaker client calculates the additional playout delay factor that should be applied to each participant client device that has been selected to also play the dynamic mix created by the Elected Speaker client (which is the combined set of streams from external participants outside this Speaker Group). The calculated playout delay factor considers the distance between speakers and other clients within the Speaker Group and attempts to minimize variability of latency across any received (over the air) audio played by the speakers and received by the microphones within the Speaker Group.

If the physical latency between speakers and microphones is too long, then the Elected Speaker may mute one or more speakers to prevent unwanted echoes. Typically, 15-20 ms is about the maximum amount of delay for which a human will correlate two different sounds as being from the same source. Different delays of similar sounds are usually interpreted as room impulses (such as room reverberation), employed by human binaural processing to calculate the position in three-dimensional space from which a sound is emanating. Once this upper range of delays is exceeded, a person is less likely to correlate two different sounds as being from the same source. Instead, the sounds may instead interfere with each other or be interpreted as echo.

To avoid this unwanted effect, if the Speaker Group includes first and second clients whose physical latencies to the microphone of a third client differ by more than 15 ms, then the Elected Speaker client may mute the first client, the second client, or both the first and second clients. The Elected Speaker client can assess which client(s) 620 in a Speaker Group to silence based on the analysis of the relative positioning of the clients 620 within a particular room, explicitly tracking those clients 620 that are being used to play audio. If the client speakers are equidistant from each other, then adjusting the play-out delay for each client's speaker(s) can account for the audio latency due to the distance between a speaker and a microphone. Problems arise when client speakers are not equidistant from each other and the distance between client speakers and microphones exceeds a threshold distance. By assessing these relative positions and distances, the Elected Speaker client can prioritize those client speakers that are farthest from each other and most nearly equidistant and silence those client speakers that are least nearly equidistant from each other.

### Mixing Streams by the Elected Speaker Client

If there are clients in many locations in the conference, each Elected Speaker client 620 can receive individual audio streams relayed from the SFU (routing module 614). In some embodiments, these individual audio streams could also be beam-formed mixes created from the audio streams originating from other Speaker Groups. But in either case, the conference server 610 or SFU 614 does not need to create dynamic mixes containing the combined streams from all the audio streams across external Speaker Groups. Creating dynamic mixes at the host platform 610 may introduce additional latency and may incur significant processing overhead, as each Speaker Group within a conference may have a “custom mix” containing only the audio streams that originate outside that Speaker Group. In a conference with multiple Speaker Groups, this could involve creating many custom mixes.

To avoid adding the latency and processing overhead of creating custom mixes at the hosting platform 610, each Elected Speaker client 620 can dynamically mix the beam-formed streams from the other Speaker Groups together in real-time. Each Elected Speaker client 620 can then relay the resultant audio mix to the other clients in its Speaker Group. The dynamic mix can be sent over a local peer-to-peer connection in order to keep network latency as low as possible.

Each Elected Speaker client may determine the maximum network latency (or RTT) between itself and each participant within its Speaker Group. For a Speaker Group with an Elected Speaker client and three other clients, for example, with RTTs to the Elected Speaker client of 2 ms, 5 ms, and 18 ms, the maximum latency for the Speaker Group is 18 ms. The Elected Speaker client sets its playout delay (the delay between sending an audio signal to the other clients in the Speaker Group and playing the audio signal on its speaker(s)) by the maximum network latency (here, 18 ms) plus an additional offset used to account for physical latency (which is the time it takes for sound to travel from the Elected Speaker's speaker to the microphone of a given participant within the Speaker Group).

This additional latency factor (or playout delay) ensures that each client within a Speaker Group receives an audio sample over the network before it captures the same audio signal, as played by the Elected Speaker, via its microphone. This playout delay enables AEC to work reliably as AEC uses a reference stream (in this case, the audio stream dynamically mixed by the Elected Speaker from the external audio streams originating from external Speaker Groups) to calculate which audio signals should be filtered out or subtracted from the audio captured by each client's microphone. Having the Elected Speaker client dynamically mix the external audio streams ensures that network latencies between each external client are consistent.

In a typical conventional VOIP conference, each participant device (client) receives each external audio stream directly and mixes these streams together itself. However, due to the dynamic and inconsistent nature of internet protocol (IP) networks, the latencies with which a participant device receives these external audio streams can vary dramatically over time. Because each participant device receives external audio streams directly and creates its own custom audio mix, this variable network latency makes it very unlikely that the audio played by one client in a conventional VOIP conference call would match the reference streams produced by the other participant devices in the same room.

Having an Elected Speaker client mix and distribute audio streams from other Speaker Groups to the other members of its Speaker Group eliminates this problem of network latency variability between the conference bridge and the Speaker Group clients. It does this by ensuring that the relative latencies for streams from external Speaker Groups are the same for each client in the Speaker Group, both for reference/AEC and audio broadcast purposes. This makes the conference more robust to varying network conditions in addition to reducing downstream network bandwidth consumption and processing overhead at the conference bridge. In addition, performing AEC with a dynamically mixed stream from an Elected Speaker client produces higher quality audio streams from the other clients.

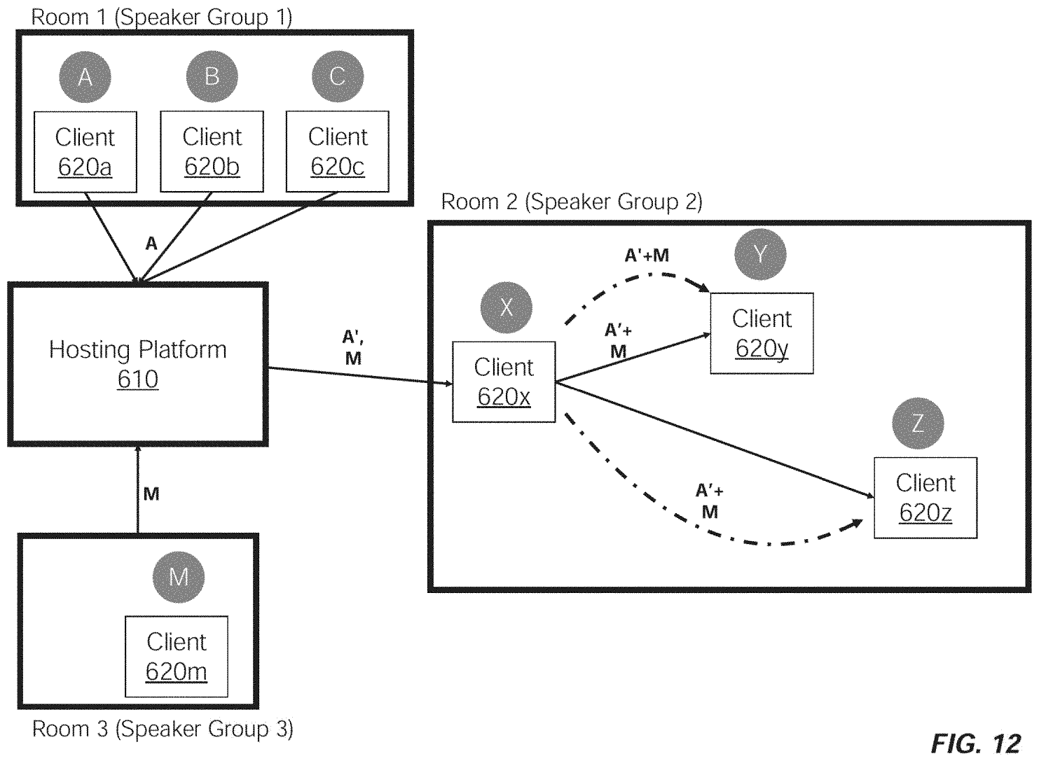

FIG. 12 illustrates how one Elected Speaker (client 620x) receives and mixes streams from multiple Speaker Groups (here, Speaker Groups 1 and 3) and distributed the mixed stream to other clients in its Speaker Group (clients 620y and 620z in Speaker Group 2). In this example, the clients 620a-620c in Speaker Group 1 capture and send audio streams (arrows A) representing speech by person A in room 1 to the hosting platform 610, which mixes them to produce a mixed audio stream A′. The hosting platform 610 also receives an audio stream representing speech by person M from client 620m in Speaker Group 3. The hosting platform 610 sends the mixed audio stream A′ and the other audio stream M to the Elected Speaker client 620x, which dynamically mixes them together to produce a mixed stream A′+M. The Elected Speaker client 620x distributes this mixed stream A′+M to the other clients 620y and 620z via a p2p network, then plays the mixed stream A′+M in room 2 (indicated by dashed arrows) after waiting for a period greater than the maximum latency of the p2p network. The clients 620x-620z in Speaker Group use this mixed stream A′+M for AEC as described above. At the same time, the hosting platform receives and sends audio signals from Speaker Groups 2 and 3 to the Elected Client in Speaker Group 1 for mixing, distribution, playback, and AEC and sends audio signals from Speaker Groups 1 and 2 to the Elected Client in Speaker Group 3 for mixing, distribution, playback, and AEC.

### Leveraging Multi-Frequency Tones to Improve Latency Prediction and Echo Cancellation

It is often difficult to accurately predict the relative latencies between a reference stream (received from the conference bridge) and an audio stream played from a different device. To mitigate this situation, the conference bridge server can embed high-pitched tones into the reference audio streams. This approach allows a client to more accurately gauge the latency between a reference stream and audio being captured on its microphone. This is accomplished by buffering these streams and comparing the relative offsets between the coinciding tones embedded in the reference stream and within the audio captured over the air (and played from the elected speaker). This approach has the added advantage of also accounting for additional latency stemming from the distance between the Elected Speaker device and the participant—which is beneficial for accurately canceling echo.

### Dual-Strategy Diarization

Dual-strategy diarization leverages speaker turn metadata, audio power or sound pressure levels (the perceived loudness of an audio signal), and a repository of user profile data that persists x-vector data to capture distinguishing characteristics of each speaker's voice. (The x-vector data represents multi-dimensional audio features that help characterize a speaker for identification by a neural network.) Through the identification, capture, and analysis of speaker change events, audio energy levels, historical audio data, and user profile data, the media processor can identify which participant within a meeting is speaking in order to associate this participant with the speech or content being uttered at that time. The content uttered by a participant and the time at which they uttered the content are persisted to iteratively improve the accuracy of the diarization and the ASR. Furthermore, this content and attribution is persisted and indexed, allowing for later content search and retrieval by participant, time, or topic.

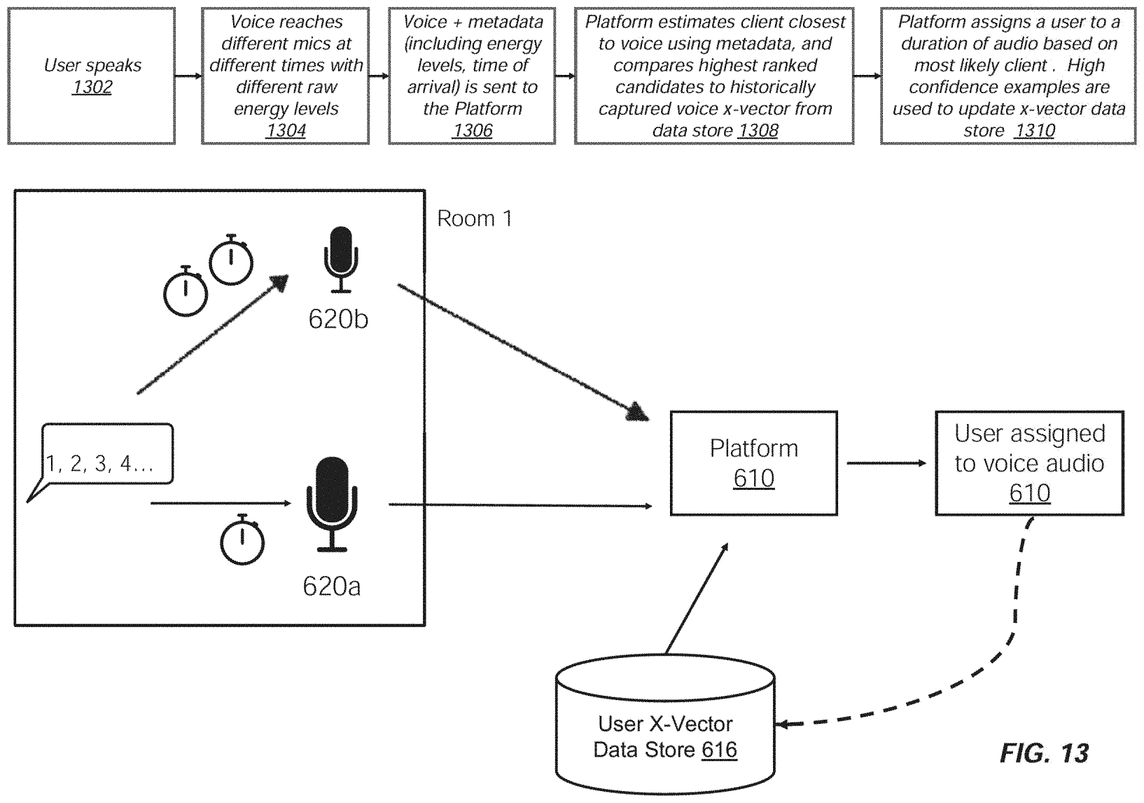

FIG. 13 illustrates a dual-strategy diarization process using microphones from at least two colocated clients 620a and 620b. When a conference participant speaks (1302), their voice reaches the microphones at different times, with different raw energy levels, unless they are equidistant to the microphones (1304). The clients 620a and 620b capture the microphone (audio) signals and audio metadata, including the volume levels and times when the voice was detected, and sends them to the hosting platform 610 (1304). The hosting platform 610 estimates which client is closest to the conference participant form the metadata and/or volume information extracted from the audio signals (1308). The hosting platform 610 computes and compares voice x-vector data for the highest-ranked candidates to previously captured voice x-vector data stored in a conference participant x-vector data store 616, which may be contained in or communicatively coupled to the hosting platform 610. The hosting platform 610 uses the results of this comparison to assign a conference participant to the captured portion or segment of the audio signal. It may use high-confidence results to update data in the x-vector data store 616.

### Iterative, Multi-Tier Context Extraction Engine

An iterative, multi-tier context extraction engine implemented in the media processor 630 iteratively improves the accuracy of transcription data by combining and correlating multiple streams of audio data by time bucket. For instance, when a user selects the next agenda item at a particular time during a meeting, that event is correlated with the audio streams recorded at that moment. As the audio streams are transcribed and diarized, it becomes possible to correlate the agenda item with the person speaking at that moment, along with the content spoken by that person (as given by the transcription).

These iteratively extracted layers of content and semantic data continue to be correlated with the corresponding time buckets. As these new layers are revealed, new insights may be further deduced and associated together. For instance, it becomes possible to associate a particular topic and agenda item with a particular speaker (the active speaker at that time) as well as what the speaker said. The media processor can continue to extract and derive new insights by associating notes taken within the same time bucket or action items created during that time. Another example is performing optical character recognition (OCR) on video streams and extracting textual data from screen-shares. The resulting content derived from this OCR process can also be dynamically associated with other streams of data coinciding with the same bucket of time.

### Aggregation of Historical Natural Language and Semantic Data for Summary and Action Item Prediction

Aggregating historical natural language and semantic data with scheduling (i.e., calendar), topical, and external project-based metadata makes it possible to track and predict project progress, infer trends, and improve the relevancy of summarization and topic detection.

### Iterative Language Model Repository for Iterative Improvement and Personalization of Language Model

Combining metadata from multiple sources with transcription, voice, and diarization data makes it possible to identify repeated usage of certain terms, words, and phrases across recurring events, meetings with the same core group of users, and other patterns. These repeated phrases and terms can be extracted and applied to the language model used to automatically recognize and transcribe conferences for the organization, team, or group of people for whom these custom terms and phrases apply.

### Semantic and Topic Detection Through Historical and Profile Data

Each sentence within a transcript, as well as key chunks of a transcript within a meeting, can be categorized and assigned one or more semantic tags, utilizing one or more semantic ontologies (e.g., using resource description framework (RDF) and Web Ontology Language (OWL), along with other OWL-based semantic ontologies). Different teams or organizations may be assigned different collections of ontologies from which to pull these semantic categories in order to allow for more specific and relevant categorization and semantic association. For instance, a team focused on healthcare or genomics may be assigned a collection of ontologies related to healthcare, biology, and genomic ontologies in addition to a range of generic ontologies.

Additionally, external data associated with a meeting may also be assigned one or more semantic categories, such as notes, external documents, agenda items, etc. These granular data-points may be aggregated across an entire meeting to derive moment-by-moment chunking to identify key topics and topical chapter points in order to facilitate better semantic indexing and navigation. Additionally, these semantic associations may also be used in aggregate across historical data in order to surface metrics and for discovery. This can be useful to identify topical changes over time or to surface key discussion points. These higher-level historical semantic groupings can then be used to correlate and associate collections of meetings across an organization to identify potential links and relevant connections that can be surfaced.

These semantic associations can be used for producing summarizations, which can be sent out in the form of regular emails to facilitate sharing and to identify key points or implicit notes across one or more meetings.

### Additional ASR and Diarization Features

The higher-quality audio produced using an inventive multi-mic system can be transcribed and diarized (e.g., in postprocessing) for extracting valuable information from audio and video conference conversations and presentations. For example, the many time-synchronized data points and integrations in the transcribed output can be used to improve relevance of search results and extract summaries for meetings. This data can be accrued and analyzed for behaviors or patterns across meetings. It can also be used to identify topic clusters within a meeting, extract the most relevant concepts discussed during a meeting, and extract key trends, topics, and sentiment over time.

The data can be used to support real-time, conversational voice-commands, without a wake word (e.g., “Alexa” or “Hey Siri”). This allows conference participants to maintain a smooth flow of the meeting discussion, without having to mention an artificial “wake word” and then await confirmation that the command was processed. Instead, the command can be processed asynchronously, by real-time analysis of the command and resulting context. Once the command has been recognized, the clients can render visual feedback on their screens for everyone. The conference participants may reject or accept this visual confirmation of the detected intent at any time during or after the meeting, without disrupting the flow of the meeting discussion.

Leveraging multiple time-synchronized data points yields more relevant search results and summarizations of transcribed audio data. These time-synchronized data points may include enhanced transcription chunks, time-synchronized notes, time-synchronized agenda items, historical data from other meetings, and time-synchronized integrations, such as user-specified links to other tools, like Jira, Asana, Figma, etc. The (key) points that can be extracted from a meeting, e.g., by the media processor, can take the forms of extractive summarizations and generative summarizations. An extractive summarization can be created by identifying the disparate topics across a meeting (e.g., different agenda items), and then extracting the most relevant, salient, and important sentences (as well as notes, agenda items, slides, actin items, references, etc.) from each topic. And a generative summarization can be created by identifying the disparate topics across a meeting, and then distill the transcribed sentences (along with the co-occurring notes, agenda items, slides, references, URLs, images, etc.) from each topic and generating new sentences that effectively communicate or paraphrase what was discussed.

Creating extractive and generative summarizations leverage the multi-mic strategy to improve the accuracy and quality of the recorded audio, as well as to extract more accurate diarization metadata. Additionally, the inventive technology captures the timing information of ancillary data and metadata (such as notes, agenda items, images, slides, references, external integrations, etc.) and is able to extract further semantic context by further analyzing these additional data, as well as clustering these data with the transcription, diarization, and historical data described above, by time. For instance, the media processor can extrapolate the context of what was said at a particular time by imbuing and layering this data with co-occurring notes, images, action items, etc. Conferences with slides or screen share have even more content for analysis—the media processor can compare slides over time (e.g., by identifying how a slide changes from one point to the next, to deduce the “emphasis,” such as a new line item that builds on previous slides). The media processor can use optical character recognition (OCR) to extract this content and additional context.

Additionally, the inventive technology allows conference participants and other users to reference external systems and software-as-a-service (SaaS) tools directly. For instance, the media processor can retrieve information via external APIs, enabling it to pull in the context, content, and/or metadata from an external product. For example, a conference bridge or media processor may integrate with a calendar system, making it possible for the conference bridge or media processor to determine which participants were invited to a given meeting (regardless of whether they were present at the meeting). By using these invitations and previously recorded audio data, the media processor may be able to match captured voices to people within an organization. The media processor can even use content from previous meetings attended by a given participant to infer context represented by that participant's presence at another meeting (e.g., based on that participant's role within the organization).

The conference bridge and/or media processor can integrate with external messaging systems, making it possible to extract additional content from external text-based conversations referenced during a given meeting. The media processor may use this data to extract additional context, including the data's significance in being mentioned at that precise moment of the meeting. The text message or information in the text message can be clustered with other co-occurring events, including transcription events, diarization events, notes, etc. as well.

Integrating the media processor 630 and media database 640 with external product management and tracking systems makes it possible for the media processor 630 to extract context and content, referenced from an external tool's digital representation of a project, a To-Do item, or a “Bug,” “User Story,” or “customer complaint or conversation” in a customer support system. Again, the media processor 630 can cluster these external data points, allowing this context to provide more meaning to transcriptions of audio or video conference sessions hosted by the multi-mic system.

Combining these co-occurring data points can provide deeper meaning and insights, e.g., in the form of improved and more relevant search results (as one manifestation of this context extraction technology). Searching the media database 640 can surface the specifics of what was actually said during the course of a meeting. These searches can also be used to deduce and leverage the context and context of slides and presentations referenced during a meeting, external conversations and references to specific To-Dos and Action Items from external systems, as well as external conversations and threads from external messaging systems and customer support systems. This provides a great amount of utility, which can be further surfaced in the summarization manifestations described above. Allowing users to search the media database 640 for specific mentions or similar information makes it possible to identify and extract meetings that reference the same or similar external projects, external conversations, slides, topics, etc.

Finally, multi-mic technology can be leveraged to produce insightful metrics and analytics that allow all of these combined data points to be analyzed over time. Through this approach, it is possible to extrapolate integral behavioral and conceptual metrics for individuals, teams, and entire companies, by extracting relevant data points and creating visual representations of these metrics over time. These metrics can provide additional insight, based on historical, contextual, and semantic data over time. They include but are not limited to: (1) extracting key topics over the course of a particular meeting and then representing the frequency of the occurrence of these topics over time; (2) mapping the amount of time a person speaks in meetings over time; (3) deducing a person's contribution patterns (i.e., how much they speak/participate) based on others present; and (4) identifying sentiment across recurring meetings.

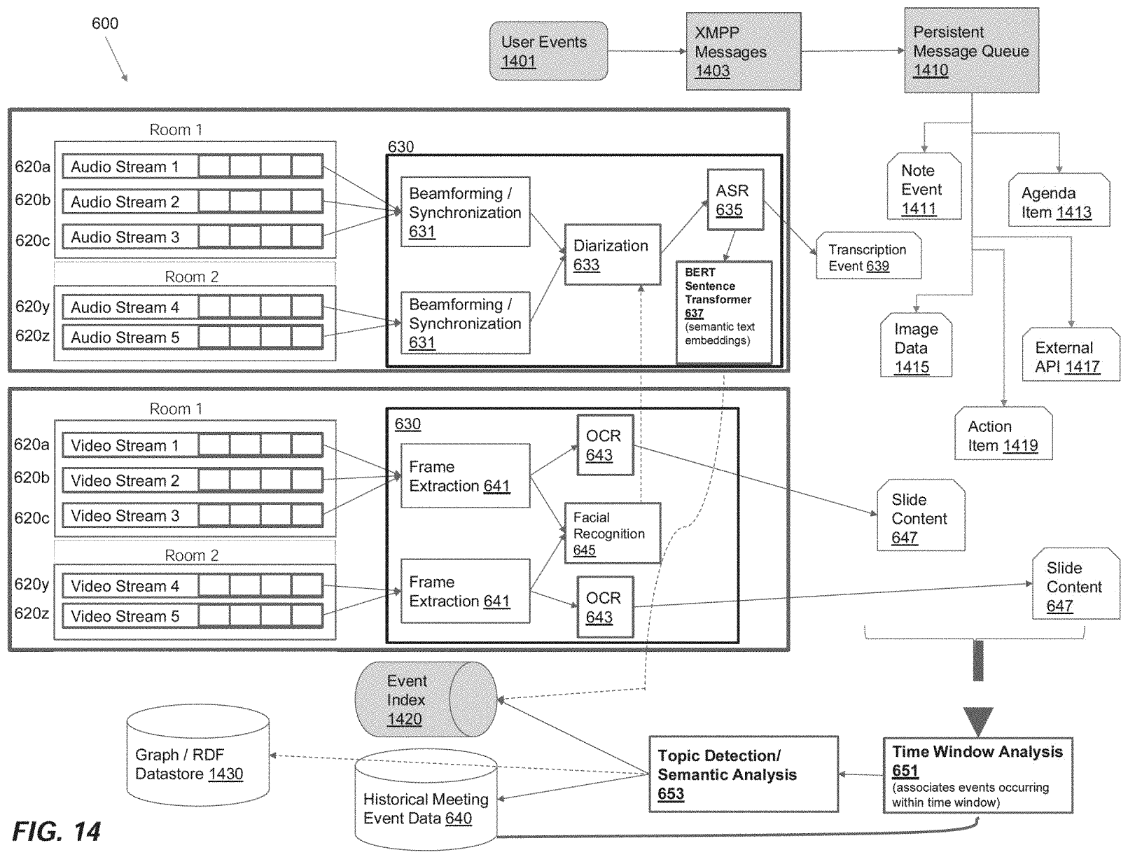

FIG. 14 illustrates how a multi-mic system 600 integrates with a persistent message queue 1410 and an event index data store 1420 to generate and store historical meeting data in the media database 640 for later searching and content and context extraction. In this example, there are two Speaker Groups, formed of clients 620a-620c in Room 1 and clients 620y and 620z in Room 2. Each client 620 acquires and sends a corresponding audio stream (top) and video stream (bottom) to the bridge server (omitted for clarity), which routes signals among the clients 620 as discussed above. The bridge server also provides the audio and video streams to the media processor 630, which processes and transcribes them. The media database 640 stores the transcriptions for retrieval and further analysis.

More specifically, the media processor 630 performs beamforming and synchronization (631), diarization (633), and ASR (635) on the audio streams as described above. The media processor 630 can perform sentence transformation based on the Bidirectional Encoder Representations from Transformers (BERT) language model and information from the event index 1420 to generate semantic text embeddings (637) for improving the quality of the transcription. The media processor 630 may also identify or tag transcription events 639, such as changes in the person speaking, based on the transcription, diarization, and semantic text embeddings.

Similarly, the media processor 630 extracts frames from the video streams provided by the clients 620 and routed by the bridge server (641). These frames may include slide share content and/or content, such as images or video of the conference participants, captured by video cameras integrated with or coupled to the clients 620. The media processor 630 performs OCR on the frames with slide share content (643), yielding slide content 647, and facial recognition data on the slides with image/video content (645). The media processor 630 may use the facial recognition data to enhance the accuracy of diarization (633).

The persistent message queue 1410 generates different types of events and other data, including note events 1411, agenda items 1413, image data 1415, external API data 1417, and image data 1419, from user events 1401 and extensible messaging and presence protocol (XMPP) messages 1403. The media processor 630 or another processor performs time-window analysis on these events, the transcription events 639, and slide content 647 as well as data from the media database 640, the event index 1420, and an RDF/graph datastore 1430. This involves associating or clustering the events, items, and content that occur or appear within each time window. This processor may also perform topic detection and semantic analysis (653) on the output of the time window analysis and on data from the media database 640, the event index 1420, and an RDF/graph datastore 1430. Additionally, the processor may pull in aggregate or historical event data from the RDF/graph datastore 1430 to extract further context, semantic, and behavioral data, needed to generate more relevant results.

The analysis performed by the media processor 630 or other suitable processor on the collected data may include analysis of conference participant speaking patterns by assessing their speech, speech patterns, and comparison of their behavior across meetings (assessing changes with different groups of users present). The historical data for this analysis can come from the graph/RDF datastore 1430, event index 1420, or media database 640. By using multi-device/multi-room audio processing and image processing, the media processor 630 can more accurately identify which people are speaking at any given time. It can also improve the accuracy and context of resulting transcription of meetings; leverage recurring meetings to identify key trends, topics, and sentiment; generate audio fingerprints for identifying users more accurately; identify critical concepts discussed within a given meeting or group of meetings; and extract salient notes, tags, action items, and transcription chunks to be used as a meeting summary.

### CONCLUSION

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize or be able to ascertain, using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

Also, various inventive concepts may be embodied as one or more methods, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e., “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

As used herein in the specification and in the claims, when a numerical range is expressed in terms of two values connected by the word “between,” it should be understood that the range includes the two values as part of the range.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

1. A method of audio/video conferencing among participants using a first client in a first room, a second client in a second room, and a third client and a fourth client in a third room, the method comprising:
connecting the third client to a server via a network connection;
connecting the third client and the fourth client via a peer-to-peer network having a latency lower than a latency of the network connection;
receiving, by the third client from the server via the network connection, a first audio signal and a second audio signal, the first audio signal representing sounds in the first room captured by the first client and the second audio signal representing sounds in the second room captured by the second client;
mixing, by the third client, the first audio signal and the second audio signal to produce a mixed audio signal;
transmitting the mixed audio signal from the third client to the fourth client via the peer-to-peer network;
playing, by the third client, the mixed audio signal with a delay greater than the latency of the peer-to-peer network;
recording, by the third client, a third audio signal representing speech by a person in the third room and the mixed audio signal as played by the third client;
canceling, by the third client, the mixed audio signal as played by the third client from the third audio signal;
transmitting, by the third client, the third audio signal to the server;
recording, by the fourth client, a fourth audio signal representing the speech by the person in the third room and the mixed audio signal as played by the third client;
canceling, by the fourth client, the mixed audio signal as played by the third client from the fourth audio signal; and
transmitting, by the fourth client, the fourth audio signal to the server without transmitting the fourth audio signal to the third client.

2. The method of claim 1, further comprising:
determining a relative offset between a clock of the third client and a clock of the fourth client; and
transmitting the relative offset to the server for synchronizing the third audio signal with the fourth audio signal.

3. The method of claim 1, wherein the third client and fourth client are in a plurality of clients in the third room, and further comprising:
exchanging messages between the third client and each other client in the plurality of clients in the third room via the peer-to-peer network;
measuring round-trip times (RTTs) of the messages between the third client and each other client in the plurality of clients in the third room;
estimating a maximum latency of the peer-to-peer network based on the RTTs; and
setting the delay for playing the mixed audio signal to be greater than the maximum latency of the peer-to-peer network.

4. The method of claim 3, wherein setting the delay comprises setting the delay to include an error margin to account for hardware latency of each client in the plurality of clients.

5. The method of claim 1, further comprising:
determining, by the server, that the third client and the fourth client are in the third room; and
selecting the third client to be the only client in the third room to receive the first audio signal and second audio signal from the server.

6. The method of claim 5, further comprising:
selecting the third client to be the only client in the third room to play the mixed audio signal.

7. The method of claim 1, further comprising:
playing, by the fourth client, the mixed audio signal with a delay selected to synchronize playing of the mixed audio signal by the fourth client with playing of the mixed audio signal by the third client.

8. The method of claim 7, wherein the delay selected to synchronize the playing is less than 20 milliseconds.

9. The method of claim 1, further comprising:
determining an identity and/or a location of the person in the third room based on the third audio signal, the fourth audio signal, and a latency between the third client and the fourth client; and
synthesizing a beamformed audio signal based on the third audio signal, the fourth audio signal, the latency between the third client and the fourth client, and the identity and/or the location of the person in the room.

10. The method of claim 9, further comprising:
transmitting the beamformed audio signal from the server to the first client and to the second client and not to the third client or to the fourth client.

11. The method of claim 9, further comprising:
transcribing the beamformed audio signal.

12. The method of claim 1, further comprising, before receiving the first audio signal by the third client:
mixing, by the server, the first audio signal from a plurality of audio streams captured by a plurality of clients, including the first client, in the first room.

13. A method for audio/video conferencing among participants in different rooms, the method comprising:
connecting clients to a server;
determining, by the server, that a subset of the clients are in a first room;
measuring latencies between the server and the clients in the subset of the clients;
designating, by the server, the client of the subset of the clients having the lowest latency to the server as an elected speaker client;
synchronizing a clock of the server with a clock of the elected speaker client;
receiving, by the server, clock offsets between the clock of the elected speaker client and clocks of the other clients in the subset of the clients;
receiving, by the server from each of the clients in the subset of the clients, a corresponding audio stream representing sounds in the first room;
aligning, by the server, the corresponding audio streams based on the clock offsets;
mixing, by the server, the corresponding audio streams to produce a mixed audio stream for the subset of the clients in the first room; and
transmitting, by the server, the mixed audio stream to a client in a second room.

14. The method of claim 13, wherein aligning the corresponding audio streams based on the clock offsets comprises:
segmenting the corresponding audio streams into respective chunks based on the clock offsets;
performing cross-correlations of the respective chunks; and
adjusting time delays of the respective chunks based on the cross-correlations.

15. The method of claim 13, wherein mixing the corresponding audio streams comprises:
estimating a location of a person speaking in the first room based on the corresponding audio streams from the clients in the subset of clients, and
combining the corresponding audio streams to emphasize speech from the person speaking in the first room.

16. The method of claim 13, wherein transmitting the mixed audio stream to the client in the second room occurs without transmitting the mixed audio stream to any of the subset of the clients.

17. The method of claim 13, wherein the subset of the clients is a first subset of the clients, the elected speaker is a first elected speaker, the client in the second room is a second elected speaker client, and further comprising:
determining, by the server, that a second subset of the clients is in the second room;
measuring latencies between the server and the clients in the second subset of the clients;
designating, by the server, the client of the second subset of the clients having the lowest latency to the server as the second elected speaker client;
transmitting the mixed audio stream from the server to the second elected speaker client; and
transmitting the mixed audio stream from second elected speaker client to other clients in the second subset of the clients via a peer-to-peer network.

18. The method of claim 17, further comprising:
transmitting, by the server, another mixed audio stream from another subset of the clients to the second elected speaker client.

19. The method of claim 13, further comprising:
performing speech recognition on the mixed audio stream; and
generating a transcription of the mixed audio stream based on the speech recognition.

20. A method of audio/video conferencing among participants using different client devices in different rooms, the method comprising:
connecting multiple client devices to a host platform, the multiple client devices comprising a client in a first room and at least two clients in a second room;
recording, by the client in the first room, a first audio signal representing speech by a person in the first room;
transmitting the first audio signal from the client in the first room to the host platform;
selecting, for the second room, an Elected Speaker client from among the at least two clients in the second room;
transmitting the first audio signal from the host platform to only the Elected Speaker client among the at least two clients in the second room;
transmitting the first audio signal from the Elected Speaker client to each other client in the second room via a local network; and
playing, in the second room, the first audio signal by only the Elected Speaker client.

21. The method of claim 20, further comprising:
determining latencies associated with the at least two clients in the second room;
capturing, by each of the at least two clients in the second room, a corresponding audio signal representing speech by a person in the second room;
synthesizing a beamformed audio signal based on the audio signals captured by the at least two clients in the second room and the latencies associated with the at least two clients in the second room; and
transmitting the beamformed audio signal to the client in the first room.

22. The method of claim 21, further comprising:
performing automatic echo cancellation, based on the first audio signal, on the audio signals captured by the at least two clients in the second room before synthesizing the beamformed audio signal.

23. The method of claim 21, further comprising:
estimating a location of the person in the first room based on the audio signals captured by the at least two clients in the first room.

24. The method of claim 21, further comprising:
estimating a location of the person in the second room based on the audio signals captured by the at least two clients in the second room.

25. A method of recording audio among people in a room using at least two clients in the room, the method comprising:
determining latencies associated with the at least two clients;
capturing, by each of the at least two clients, a corresponding first audio signal representing speech by a person in the room;
determining an identity and/or a location of the person in the room based on the first audio signals and the latencies;
synthesizing a second audio signal based on the first audio signals captured by the at least two clients, the latencies, and the identity and/or the location of the person in the room; and
transcribing the second audio signal.
